(19) United States
(12) Patent Application Publication
(10) Pub. No.: US 2026/0170231 A1
(43) Pub. Date: Jun. 18, 2026

(54) Automated Communication Systems, Methods, and Tools

(71) Applicant: Duarte Press LLC, Santa Clara, CA (US)

(72) Inventors: Michael Duarte, Mountain View, CA (US); Chariti Canny, Des Moines, WA (US)

(21) Appl. No.: 19/418,134

(22) Filed: Dec. 12, 2025

Related U.S. Application Data
(60) Provisional application No. 63/735,569, filed on Dec. 18, 2024.

(51) Int. Cl. G06F 40/106; G06F 16/438; G06F 40/109; G06F 40/169

(52) U.S. Cl. CPC G06F 40/106; G06F 16/4393; G06F 40/109; G06F 40/169

(57) ABSTRACT

Systems and methods for automated presentation generation are described. One aspect includes a computing system receiving data, including textual data and one or more user-provided graphical elements, to create a presentation, and receiving one or more user inputs providing information related to the presentation. The computing system may automatically select one or more presentation graphical elements including zero or more of the user-provided graphical elements, and generate a plurality of design elements for the presentation, the design elements comprising a combination of textual elements and the presentation graphical elements. The computing system may calculate, based on an aspect ratio, a size and a position of each of the one or more design elements, on one or more slides associated with the presentation, resize the design elements based on the calculating, and finalize the presentation by placing each design element at a respective calculated point on an associated slide.

### RELATED APPLICATION

This application claims the priority benefit of provisional patent application No. 63/735,569, titled “Automated Communication Systems, Methods, and Tools” filed on Dec. 18, 2024, the disclosure of which is incorporated by reference herein in its entirety.

### TECHNICAL FIELD

The present disclosure relates to systems and methods to automatically generate one or more visual narratives, including presentations.

### BACKGROUND ART

The effectiveness of a speaker is greatly enhanced by a visual narrative or presentation that is able to capture the attention and interest of the audience. Traditionally, presentations (e.g., PowerPoint presentations) are written and designed manually by a speaker or a human professional presentation designer or business storyteller. Recent advances in the field have seen the emergence of systems and methods that capture user inputs and automatically generate a narrative or presentation based on the user inputs. However, none of these systems and methods appropriately incorporate audience empathy, story and presentation design decisions that automate the process of resonating with an audience, by enabling the speaker to engage their audience's attention. For example, a presentation may need persuasive elements that enable an emotional connection between the speaker and the audience. Such an emotional connection is especially important to appeal to the audience and persuade the audience to be receptive of the speaker's arguments and organization's goals. Contemporary presentation copilots, “AI magic” and design systems and methods do not include such features, and lack content that is influenced by audience empathy as they create cliché structures, story, imagery and layouts.

### SUMMARY

Aspects of the invention are directed to automated visual narrative and/or presentation generation systems and methods. One aspect includes receiving data, including textual data and one or more user-provided graphical elements, to create a presentation. One or more user inputs providing information regarding a context of the visual presentation, an intended audience, and an anticipated receptivity of the intended audience may be received. Persuasive text for the presentation may be generated, wherein the generating is based on the data and the user inputs. In one aspect, one or more presentation graphical elements including zero or more of the user-provided graphical elements are automatically selected.

A plurality of design elements for the presentation, the design elements comprising a combination of textual elements and the presentation graphical elements may be generated. In one aspect, the textual elements are generated based on the persuasive text. An aspect ratio for the presentation may be determined, based on which a size and a position of each of the one or more design elements, on one or more slides associated with the presentation is calculated. The design elements may be resized based on the calculating. The presentation may be finalized by placing each design element at a respective calculated point on an associated slide.

Another aspect includes receiving including training textual data and one or more training graphical design elements, associated with generating a presentation. The training data may be categorized into one or more structural and hierarchical formats, and one or more taxonomies. An artificial intelligence (AI)-based system may be configured to automatically compute a layout and a size of each of one or more presentation elements comprising any combination of one or more textual elements derived from the training textual data, and one or more presentation graphical elements selected from the training graphical design elements on a given layout associated with the presentation. The AI-based system may be further configured to automatically recognize a theme and automatically generate the presentation based on the theme. A user-requested presentation may be automatically generated based on the configuring and the presentation data.

One or more presentation graphical elements including zero or more of the user-provided graphical elements may be automatically selected, and a plurality of design elements for the presentation may be generated. The design elements may be comprised of a combination of textual elements and the presentation graphical elements, with the textual elements being generated based on the persuasive text.

A size and a position of each of the one or more design elements, on one or more slides associated with the presentation may be calculated based on a calculated aspect ratio for the presentation. The design elements may be resized based on the calculating, and the presentation may be finalized by placing each design element at a respective calculated point on an associated slide.

Another aspect includes a computing system providing a graphical user interface to a user on a user computing device that enables the user to interact with the computing system. The graphical user interface presents a selection choice of at least one communication enhancement tool. The computing system may be configured to receive a user selection associated with a communication enhancement tool integrated into the processing system, and receive user data related to an analysis request from the user, wherein the user data is any combination of textual data and one or more graphical elements. The selected communication enhancement tool may be configured to analyze the textual data and the graphical elements, provide an iterative dialog with the user based on the analysis, wherein the iterative dialog includes providing the user with an opportunity to provide additional user data further analyze the additional user data, derive meaning of the textual data and the graphical elements from the user data and the additional user data based on the analysis and the further analysis, and provide feedback to the user based on the derived meaning, where the feedback includes recommendations for the user to modify the user data.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram of a computer architecture configured to implement an automated presentation generation system.

FIG. 2 is a block diagram of a computer architecture configured to implement an automated presentation generator.

FIG. 3 is a block diagram of a processing system.

FIG. 4 is a flow diagram depicting an empathy walk (EW) process.

FIG. 5 is a flow diagram depicting a slidemap architect (SMA) process.

FIG. 6 is a flow diagram depicting a Slide Writer (SW) process.

FIGS. 7A and 7B are flow diagrams depicting various interfaces between different subsystems of the automated presentation generation system.

FIG. 8 is a block diagram depicting an output phase.

FIG. 9 is a flow diagram depicting an automated presentation generation system user workflow.

FIG. 10 is a flow diagram depicting an automated presentation generation system user workflow.

FIG. 11 is a screenshot of a graphical user interface associated with the automated presentation generation system.

FIG. 12 is a screenshot of a graphical user interface associated with the automated presentation generation system.

FIG. 13 is a screenshot of a graphical user interface associated with the automated presentation generation system.

FIG. 14 is a screenshot of a graphical user interface associated with the automated presentation generation system.

FIG. 15 is a screenshot of a graphical user interface associated with the automated presentation generation system.

FIG. 16 is a screenshot of a graphical user interface associated with the automated presentation generation system.

FIG. 17 is a screenshot of a graphical user interface associated with the automated presentation generation system.

FIG. 18 is a screenshot of a graphical user interface associated with the automated presentation generation system.

FIG. 19 is a screenshot of a graphical user interface associated with the automated presentation generation system.

FIG. 20 is a screenshot of a graphical user interface associated with the automated presentation generation system.

FIG. 21 is a screenshot of a graphical user interface associated with the automated presentation generation system.

FIG. 22 is a screenshot of a graphical user interface associated with the automated presentation generation system.

FIG. 23 is a screenshot of a graphical user interface associated with the automated presentation generation system.

FIG. 24 is a screenshot of a graphical user interface associated with the automated presentation generation system.

FIG. 25 is a screenshot of a graphical user interface associated with the automated presentation generation system.

FIG. 26 is a flow diagram of a method for configuring an artificial intelligence (AI) engine.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, a magnetic storage device, and any other storage medium now known or hereafter discovered. Computer program code for carrying out operations of the present disclosure may be written in any combination of one or more programming languages. Such code may be compiled from source code to computer-readable assembly language or machine code suitable for the device or computer on which the code can be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It is also noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Aspects of the systems and methods described herein are related to an automated process to generate a presentation that incorporates empathic and persuasive elements that help a speaker connect with an audience. In one aspect, an automated presentation generation system as described in the present disclosure is configured to receive one or more presentation or audience-related inputs from a user. These inputs include user inputs regarding, for example, how the speaker/user perceives the audience will receive the associated content (e.g., more or less receptive). The systems and methods then process all these inputs (e.g., via an artificial intelligence (AI)-based system) to generate an output slide deck for the user.

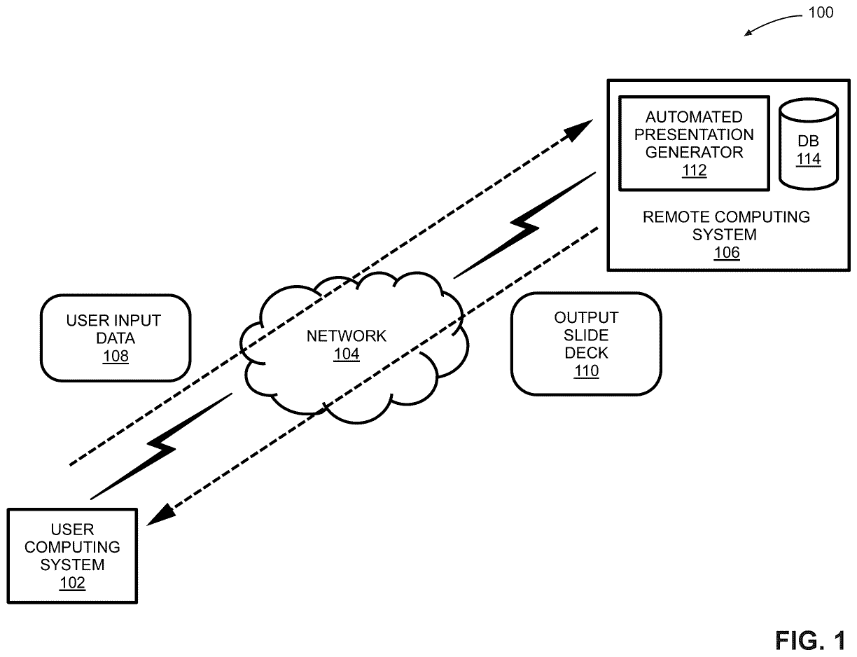

FIG. 1 is a block diagram of a computer architecture configured to implement an automated presentation generation system 100. As depicted, automated presentation generation system 100 includes user computing system 102, network 104, and remote computing system 106. Remote computing system 106 further includes an automated presentation generator 112, and a database 114.

In an aspect, each of user computing system 102 and remote computing system 106 are connected to and configured to communicate with each other via network 104. As such, a computing system described herein is a system that includes at least one processor, a memory, and a network connection. A user associated with user computing system 102 may wish to generate a presentation based on a set of choices or parameters. These parameters may be input by the user on computing system 102 via a graphical user interface presented on user computing system 102 by remote computing system 106. For example, remote computing system 106 may present the graphical user interface to the user via a web browser interface.

In an alternate embodiment, the user interface may be presented via an application software running on user computing system 102. This application software may be configured to communicate with remote computing system 106, via network 104. Remote computing system 106 may communicate data associated with the graphical user interface to user computing system 102 via network 104. Network 104 may be a public network (e.g., the Internet), or a private network (e.g., an Intranet). In an aspect, remote computing system 106 may be implemented on a server that may be further implemented on a cloud computing system.

In an aspect, the user-input parameters may be transmitted to remote computing system 106 as user input data 108, via network 104. Remote computing system 106 receives the data, processes the data, and generates an output slide deck 110 that is transmitted back to the user computing system 102 via network 104. The user can then retrieve output slide deck 110, and either directly use output slide deck 110 to present, or modify output slide deck 110 to meet their requirements. In an aspect, output slide deck 110 is a Microsoft PowerPoint slide deck, where PowerPoint presentations are uploaded, processed, finalized and downloaded as . pptx files. In other embodiments, other presentation formats such as Google Slides, Apple Keynotes, Portable Document Format (. pdf), and so on, may be supported and offered as options by the automated presentation generation system.

In an aspect, user input data 108 received by remote computing system is stored on database 114. The processing of user input data 108 along with other data stored on database 114 may be performed by automated presentation generator 112. Automated presentation generator 112 may be configured to generate output slide deck 110 using the systems and methods described herein.

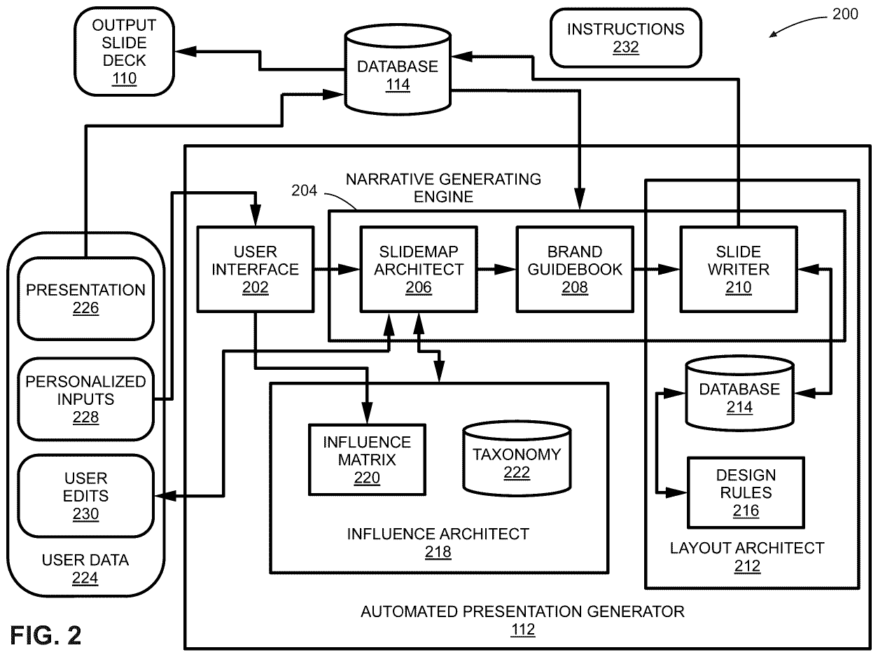

FIG. 2 is a block diagram of a computer architecture configured to implement automated presentation generator 200. Automated presentation generator 200 may be used to implement automated presentation generator 112. Automated presentation generator 200 may be configured to implement aspects of the automated presentation generation process.

As depicted, automated presentation generator 200 includes user interface 202, influence architect 218, narrative generating engine 204, and layout architect 212. Narrative generating engine 204 further includes slidemap architect 206, brand guidebook 208, and slide writer 210. Layout architect 212 further includes database 214 and design rules 216. Influence architect 218 includes influence matrix 220 and taxonomy 222. All data communicated between user computing device 102 and remote computing system 106 may be categorized as user data 224. User data 224 may further include data structures presentation 226, personalized inputs 228, and user edits 230.

In an aspect, a user uploads presentation 226 (e.g., presentation, document, spreadsheet, etc.), to automated presentation generator 200. Presentation 226 may be a part of user input data 108. This upload may be performed by the user uploading the presentation 226 via user computing system 102 to remote computing system 106, via network 104. All use-related r files (including uploaded files/presentation 226 and files generated by the automated presentation generator 200) may be stored on database 114 on remote computing system 106. In an aspect, presentation 226 is an initial draft of a presentation that includes one or more textual elements and one or more graphical elements.

The automated presentation generator 200 may then present a series of questions to the user. The user's answers to these questions are received by automated presentation generator 200 as a part of personalized inputs 228. In an aspect, the series of questions being answered by the user as a part of personalized inputs 228 may be referred to as an “Empathy Walk” (EW), to associate the slide presentation process with empathizing, or emotionally connecting with the audience. The user may choose or modify the proposed Empathy Walk output depending on the user goals for the final presentation design. Personalized inputs 228 may be a part of user input data 108.

User data 224 may also include one or more user edits 230 made by a user to one or more iteratively-designed versions of the presentation. In other words, automated presentation generator 200 may send a version of a presentation automatically generated by automated presentation generator 200 to a user, the user may respond with one or more user edits 230. Automated presentation generator 200 may then revise the presentation based on the user edits 230, and send the revised presentation to the user. This edit-revision process may be repeated till the user is satisfied with the revised presentation.

In an aspect, a combination of the user upload (i.e., presentation 226) and the responses to the Empathy walk (i.e., personalized inputs 228)) are received by the automated presentation generator 200 as a part of user input data 108. A slide parser may use a large language model (LLM) to identify, and code to prepare to store images, descriptions, prose, data, graphical positions, visual improvements and brand attributes contained within presentation 226 and personalized inputs 228 in database 114.

The following discussion presents details about the different components of automated presentation generator 200.

### User Interface 202

In an aspect, user interface 202 is configured to enable a user to interact with automated presentation generator 200. User interface 202 may be implemented as a graphical user interface on user computing system 102. User interface 202 may accept user inputs (e.g., user data 224) in the via standard computer interface protocols, e.g., mouse/trackpad inputs, keyboard inputs, touchscreen inputs, voice inputs, etc. User interface 202 may also present audio-visual data to the user, e.g., on a video monitor or screen, a loudspeaker, etc. User interface 202 may be associated with the following data structures and functionalities:
Presentation Upload 226: A user uploads user input data 108 (e.g., a document or presentation containing text and/or graphical elements), that is received by user interface 202. User interface 202 identifies if there are speaker notes in user input data 108 and if so, collects the speaker notes. The user data 108 may be converted to PNG, and an LLM describes each slide in detail, identifies the graphic location of elements via a grid system and describes how to improve each slide.
Personalized inputs 228: As a part of the empathy walk, personalized inputs 228 are user responses to a set of questions that guides a communicator (i.e., the user) through the process of understanding and connecting deeply with an audience so that all content developed uses empathy as a filter in its construction by the automated presentation generator. The user choices during the empathy walk shape how the output is constructed to uniquely appeal to each audience.

User Edits 230: Users can edit and/or re-arrange the slides in a Slidemap user interface (UI) which is called a StoryMap on a graphical user interface presented to the user. The user can regenerate or re-write titles and supporting points. This information informs the brief the slide writer 210 receives.

### Influence Architect 218

The influence architect 218 is configured to process the personalized inputs 228 from the empathy walk to translate these inputs into persuasive design elements to be used in constructing output slide deck 110. The components included in influence architect 218 are described below.

Influence Matrix 220: In an aspect, the influence matrix 220 implements algorithms on the automated presentation generator 220 to transform empathy into influence. It delivers persuasion statements to the slide writer 210 to weave (e.g., include) into the speaker notes. In addition, the influence matrix 220 generates one of more of the following:
Instructions for Persuasion Elements usage: The empathy walk elements are analyzed by artificial intelligence/machine learning (AI/ML) and re-written as one or more persuasive elements, and stored for use by the slide writer 210.
Instructions for writing to influence: The instructions on how to write to appeal to varying audiences. Content written may appeal to the positional hierarchy of the audience, their industry, how their role is measured, and through common ground generated with the presenter. An index modifies the percentages of analytical and emotional appeal based on the audience.
Instruction to design memorable moments: Based on a S.T.A.R. Moment which stands for “something they'll always remember”, these instructions craft opening gambits, anecdotes, shocking statistics, clever concepts, and memorable dramatizations to create peak moments in the presentation.
Sparkline: Carefully designs contrast into the narrative by traversing between what is and what could be at the structure and prose level.
Prompt System: The variable prompt system (not shown in FIG. 2) is a dynamic framework that uses a collection of structured instructions to generate outputs tailored to specific user inputs and system requirements. By leveraging user-provided data and internal system logic, the prompts are strategically chained in a sequential process to produce cohesive and contextually-relevant solutions. This system enables the seamless integration of multiple instructional components, such as audience empathy, storytelling elements, and visual design logic, ensuring that the generated content is both impactful and aligned with the desired objectives.
Narrative Taxonomy 222: Narrative taxonomy contains an exhaustive and complete collection of role-based narrative structures for various industries, roles and types of presentations each role delivers. A master narrative is defined and proliferates across the output presentation using multiple slide type choices of this taxonomy that may support the narrative. One example is that a sales role would use a ‘first call deck’ as part of their sales cycle. The role-based narratives have several slide types associated with a master narrative that automates the selection of slides that are most appropriate to convey role-based information. The narrative taxonomy 222 may be a deep taxonomy constructed from a large number (i.e., thousands) of slides sorted into major narrative themes with associated slide type. In one aspect, the narrative taxonomy 222 is generated by a human analyst. The narrative taxonomy 222 may be used as a basis for a role-based presentation narrative machine learning model.

The automated presentation generator 200 output may include the following kinds of presentation types:
Storyline: Creates an empathy-based storyline in outline form from scratch, created based on data stored in database 114. The storyline may be used as an option for brainstorming or building out one or more new concepts.
Storyboard: Transforms existing content into a storyboard presentation, complete with speaker notes and visual ideas. The storyboard may be used for gaining alignment or to hand off to a designer. The storyboard may be created based on data stored in database 114
Slideshow: Creates new or transforms existing content (e.g., content stored in database 114) into a presentation, complete with speaker notes, images, layouts and on-screen text.
Slidedoc: Transforms dense information into an executive-friendly summary that is easy to skim-browse. This can be used for presenting a recommendation or a concise update.

### Narrative Generating Engine 204

A narrative generating engine 204 is included in some aspects of the automated presentation generator 200. The narrative generating engine may include the following components (not all of these components are depicted in FIG. 2):
Slidemap Architect 206: Slidemap architect 206 creates a comprehensively detailed outline with a brief of the entire presentation including the title and purpose for each slide which visually builds a story map for the user. The slidemap architect 206 synthesizes the data/files uploaded by the user (received by slidemap architect 206 via user interface 202) and proposes information to re-use, as well as proposes new information for the user to research. Slidemap architect 206 may be configured to shape the structure of the presentation into a stronger narrative than the original user upload (i.e., presentation 226). Based on user input, slidemap architect 206 automatically pulls variable documents, datasets, and instructions for narrative structures from the influence architect 218.
Brand Guidebook 208: The brand guidebook 208 is an automated tool that reads presentations and documents uploaded by one or more users (e.g., presentation 226 and/or personalized inputs 228) and harvests the indicated brand voice from the prose, look/feel, layouts and other insights to be passed along through the generator to the output presentation 110. The brand guidebook 208 may be further configured to construct visual and voice guidelines over time with use. Or, the brand guidebook 208 can be built as a service.
Slide Writer 210: In an aspect, the slide writer 210 writes speaker notes and on-slide content based on the brief provided by the slidemap architect 206. The slide writer 210 has a proprietary instruction set for writing influential prose and sticky titles. The slide writer 210 may collaborate with the layout architect 212 to ensure that the speaker notes have a proper related visual. The slide writer 210 confirms slide or object re-use from the user upload e.g., presentation 226 and/or personalized inputs 228) or proposes thumbnail sketches which depict new layouts that correspond to the narrative that is being written by slide writer 210. The slide writer 210 may include one or more artificial intelligence/machine learning (AI/ML) components that automatically write the speaker notes and the on-slide content. The selection of one or more appropriate visual elements to correspond to the speaker notes may be automatically performed by the AI/ML components associated with the slide writer 210. The slide writer 210 may use some of the information in the influence matrix 220.

### Layout Architect 212

In an aspect, layout architect 212 includes a database 214 of instructions for understanding how the audience affects the visuals and goals of the content. The layout architect 212 may be configured to determine slide layouts, slide visuals, and slide text, and identify the most appropriate visual combination based on the content the Slide Writer component (described subsequently) is building. The Layout Architect may include the following components:

### Visual Guidebook

Not explicitly depicted in FIG. 2, the visual guidebook may include:
Instructions for understanding the elements of a presentation visual/slide.
Instructions for applying design principles within the constraints and requirements of a presentation visual.
Instructions for identifying diagrammatic and data-driven content (e.g., charts and tables) and producing visual representations of these presentation design elements.
Instructions for writing text in specific structures and styles on slides.
Layout Logic: Not explicitly depicted in FIG. 2, the layout logic is a syntax system created to inform one or more AI components of the system (i.e., automated presentation generator 200) regarding how to recognize layouts and convey layout decisions (e.g., layout logic and the output instructions). Instructions for how to make layout decisions within the presentation medium may also be provided by the layout logic. The layout logic may also provide instructions for combining the intention of speaker notes or other text content (e.g., a slidedoc) with visual expression that fits within the constraints of the medium. Layout Logic conveys how to navigate the available layout sketches or master layouts (for slideshow, storyboard or slidedocs) and includes the chosen layouts or layout sketches in the presentation output.
Diagram Logic: Not explicitly depicted in FIG. 2, the diagram logic is a syntax system created to inform one or more AI systems implemented on the automated slide generator 200 about how to recognize content that is appropriate for business diagrams, determine diagram structure, and convey diagram decisions (i.e., Layout Logic and the output prompt). The diagram logic conveys how to navigate the available diagram templates and includes them in the presentation output. The system uses parts of speech and visual element decisions to turn words into a definition of the best diagram choice. In one aspect, the AI/ML systems are trained to automatically analyze textual (speech/spoken) and visual contents of the presentation uploaded by the user, and automatically populate the output presentation slide deck with retrieved visual elements (including, for example, one or more images) that visually correspond to and provide visual support for the text of the presentation by showing relationships between items on the slide.
Slide template and Diagram taxonomies: Not explicitly depicted in FIG. 2, the slide template and diagram taxonomies are related to a retrieval and matching process that connects the narrative content created from the combination of the user inputs (empathy walk and user upload) and the automated presentation generator 200 to a taxonomy of slide templates and diagrams. The comprehensive classification covers the types of content and slides produced by various verticals, departments, and roles allowing for precise matching of content to slide templates and diagrams.

Templates have placeholder layouts, placeholder slide objects, and instructions on how to use and adapt the slides by the user. Upon finding matches, the system (i.e., automated presentation generator 200) selects the template intended to support audience requirements as determined by the user inputs. In one aspect, the taxonomy is uploaded into the remote computing system 106, by a system administrator. The taxonomy may be generated based on a dataset or sample space that contains a large number of templates and/or completed slides and slide presentations with narrative structures. A continuously-updated taxonomy can further be used to train the AI/ML components of the automated presentation generation system.

The layout architect may also include any combination of the following:
Instructions for understanding the elements of a presentation visual/slide.
Instructions for applying design principles within the constraints and requirements of a presentation visual.
Instructions for understanding how the audience affects the visuals and how visuals affect the audience.
Instructions for combining the intention of speaker notes or other text content (slidedoc) with visual expression that fits within the constraints of the medium.
Instructions for identifying diagrammatic and data-driven visuals (charts and tables) and producing visual representations of them.
Instructions for spatially locating visual elements for retrieval and reuse.
Instructions for how to make layouts decisions within the presentation medium.
A novel syntax system created to inform one or more AI components of the system how to recognize layouts and convey layout decisions (i.e., Layout Logic and the output instructions).

In an aspect, the layout architect, visual guidebook, layout logic, diagram logic, and slide template and diagram taxonomies are implemented by any combination of database 214 and design rules 216.

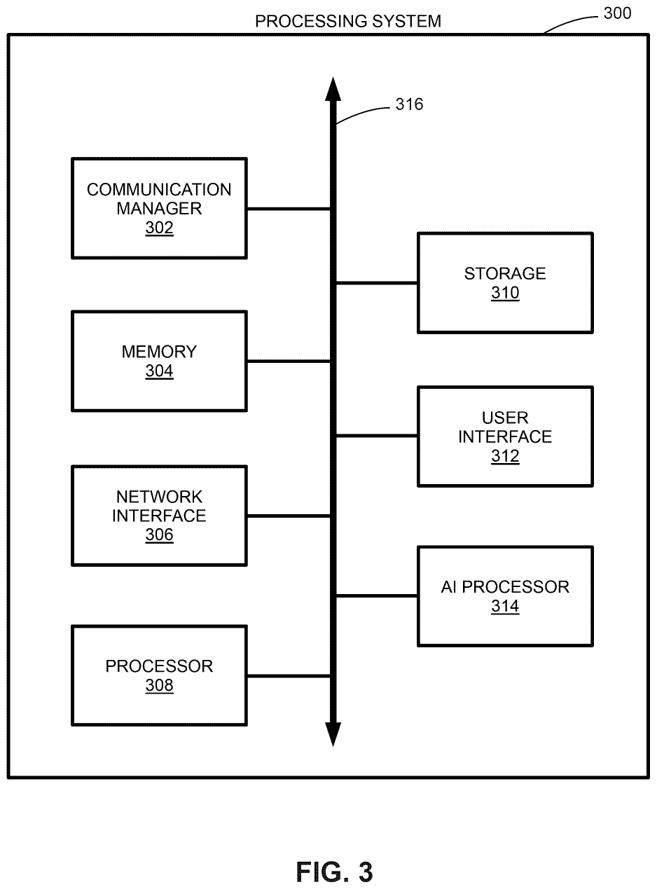

FIG. 3 is a block diagram of a processing system 300. As depicted, processing system 300 includes processing system architecture includes communication manager 302, memory 304, network interface 306, processor 308, storage 310, user interface 312, AI processor 318, and system bus 320.

Processing system 300 may be used to implement aspects of the systems and methods described herein. For example, processing system 300 can be used as a basis for implementing aspects of user computing system 102 and/or remote computing system 106.

In an aspect, communication manager 302 is configured to manage communication protocols and associated communication with external peripheral devices as well as communication with other components in user computing system 102 and/or remote computing system 106.

In an aspect, memory 304 includes a non-transitory computer medium. Memory 304 may be comprised of any combination of volatile and non-volatile memory components. Examples of components that may be used to implement memory 304 include random-access memory (RAM), read-only memory (ROM), electrically-erasable programmable read-only memory (EEPROM), flash memory, magnetic memory, optical memory, and so on. Memory 304 may include machine-readable instructions that may be executable by a processor such as processor 308. These machine-readable instructions when executed by the processor 308 cause the processor 308 to perform one or more method steps of an embodiment described herein.

Network interface 306 may be used to interface processing system 300 with other computing devices and/or computer networks. Examples of computer networks include a local area network (LAN), a wide area network (WAN), the Internet, and so on. Network interface 306 may support any combination of wired and wireless connectivity/communication protocols such as Ethernet, Wi-Fi, Bluetooth, ZigBee, etc.

A processor 308 included in some embodiments of processing system 300 is configured to perform functions that may include generalized processing functions, arithmetic functions, and so on. Processor 308 is configured to process information associated with the systems and methods described herein. Processor 308 may be configured as any combination of microcontrollers, microprocessors, digital signal processors (DSPs), field-programmable gate arrays (FPGAs), graphics processing units (GPUs), accelerated processing units (APUs), central processing units (CPUs), application-specific integrated circuits (ASICs), and so on. Processor 308 may be embodied as a single-core processor, or a multi-core processor. Processor 308 may be implemented as a centralized processor, or in a distributed manner (e.g., a distributed computing system).

Processing system 300 may include storage 310, that further includes one or more long-term storage devices such as hard disk drives, magnetic drives, magnetic tape, optical storage media (e.g., compact disks (CDs) or digital versatile disks (DVDs)), and so on. Storage 310 may be implemented as a non-transitory computer-readable medium. Storage 310 may be configured to store data and/or instructions related to the operation of processing system 300.

User interface 312 allows other devices or a user to interact with embodiments of the systems described herein. User interface 312 may include any combination of user interface devices such as a keyboard, a mouse, a trackball, one or more visual display monitors, touch screens, incandescent lamps, LED lamps, audio speakers, buzzers, microphones, push buttons, toggle switches, and so on. User interface 312 may alco include interfaces such as USB, Thunderbolt and FireWire that enable processing system 400 to interface with different devices.

AI processor 314 may be configured to implement one or more AI-related components that implement the workflows and processes of the systems and methods described herein.

System bus 316 communicatively couples the different components of processing system 300, and allows data and communication messages to be exchanged between these different components.

Processing system 300 may be used to implement aspects of remote computing system 106 and computing system 102.

From a system workflow perspective, the automated presentation generation system 100 operation includes the following sequence of phases:
Empathy walk
Slidemap Architect
Slide writer
Output

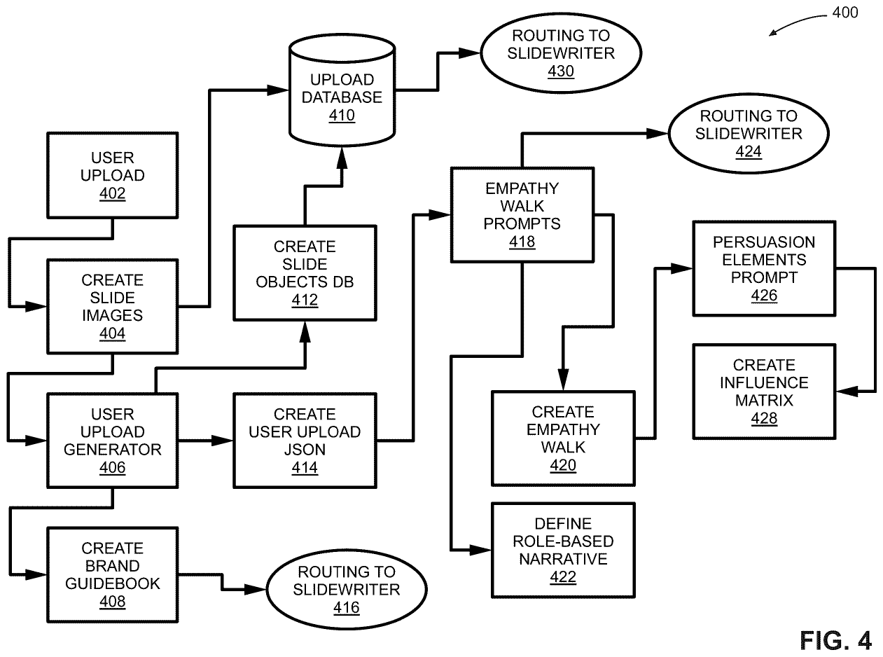

FIG. 4 is a flow diagram depicting an empathy walk (EW) process 400. Process 400 depicts a workflow where a user uploads documents (e.g., PowerPoint, Keynote, PDF, Word, Excel etc.) containing reference material and ideas about what the user would like to present, to automated presentation generator 112. The automated presentation generator 200 then prompts the user and guides the user through an empathy walk process, where the user answers one or more questions related to the user's intended goals for the presentation. In an aspect, the empathy walk process prompts the user to upload one or more slides as a part of the user upload, which are then converted to images and parsed with one or more large language models (LLMs) and code.

Process 400 may include the following steps:
Empathy Walk (App interface associated with, for example an application software running on user computing system 102)
User uploads documents to automated presentation generator (402).

Automated presentation generator 200 processes the user uploads and creates images of upload files (404).

User Upload (UU) Generator (406) routes slide images to subsequent stages in process 400.

Slide objects and image representations of slides from 404 are stored in an upload database 410.

AI parses the upload file images from user upload generator 406, and creates JSON based on the parsed data (414).

At 408, AI identifies brand elements based on data from user upload generator 406, and routes identified brand elements to the slidewriter 210 at 416. (As described herein, slidewriter 210 is also referred to as “Slide Writer 210”).

Data from user upload generator 406 may also be sued to create a slide objects database 412, which is then stored in upload database 410. Some or all data stored in upload database 410 may be routed to the slidewriter 210 at 430.

User provides information about the audience for the output presentation via one or more empathy walk prompts (418). Information provided by the user via the empathy walk prompts 418 may be routed to the slidewriter 210 at 424.

At 420, AI (e.g., AI processor 314) converts user answers into detailed collection of audience information, EW (e.g., creates EW).

At 422, AI (e.g., AI processor 314) identifies one or more role-based narratives.

At 426, AI (e.g., AI processor 314) converts EW into one or more persuasion elements, and then creates an influence matrix (428).

In process 400, there are multiple data structures that may be passed to other components of automated presentation generator 200.
Audience Empathy elements: Passed to and used by Slidemap Architect 206 and by Slide Writer 210.
Persuasion Elements: Passed to and used by Slide Writer 210.
User Upload (JSON): Passed to and used by Slidemap Architect 206 and by Slide Writer 210.
Brand Elements: Passed to and used by Slide Writer 210 and stored as a profile.
Upload Database objects: Passed to and integrated into output presentation by code.

In one aspect, the empathy walk process prompts the user to upload files which are parsed by AI/ML algorithms in the automated presentation generator and converted to JSON files (e.g., sequence 402, 202, 406, and 414). The files include a description of the information that the AI/ML systems (e.g., AI processor 314) “see” on the slide, and an interpretation of what the information means. The AI perspective is driven by an LLM and a detailed prompt system to give the AI/ML systems added insight about how to understand the information it sees.

The JSON file may include data that represents meaning-making of the uploaded user information, what this information means, and one or more objects, including text, images, data forms (e.g., charts, tables, etc.), and/or diagrams. This file of information then becomes part of the Empathy Walk process, where the user choices are recorded. The file is referenced throughout the process and throughout further prompts as the User Upload (UU).

Next, the Empathy Walk choices are merged into prompts, along with the JSON from the user upload, to produce meaning-like output. In an aspect, the empathy walk is created to persuade the audience and may be referred to as an Audience Empathy Walk. A file of the combined empathy walk choices, built into decision-making statements through prompts, may be given to the Slidemap Architect (SMA) 206 in the Slidemap Architect phase. As its base, the Slidemap Architect 206 contains comprehensive instructions, and these plus the outputs of the user inputs are added to the LLM knowledge for making narrative and design decisions. The Audience empathy walk is also provided in a prompt that creates another reference file that is part of the Influence Matrix (428), the Persuasion Elements (PE).

In one embodiment, the persuasion elements, the user upload, and the Empathy Walk are forwarded to the subsequent phases of the workflow. In one aspect, the user upload and the empathy walk are input to the slide map architect 206 in the slidemap phase, while the persuasion elements are directly forwarded ahead to the slidewriter 210 for the Slide Writer phase.

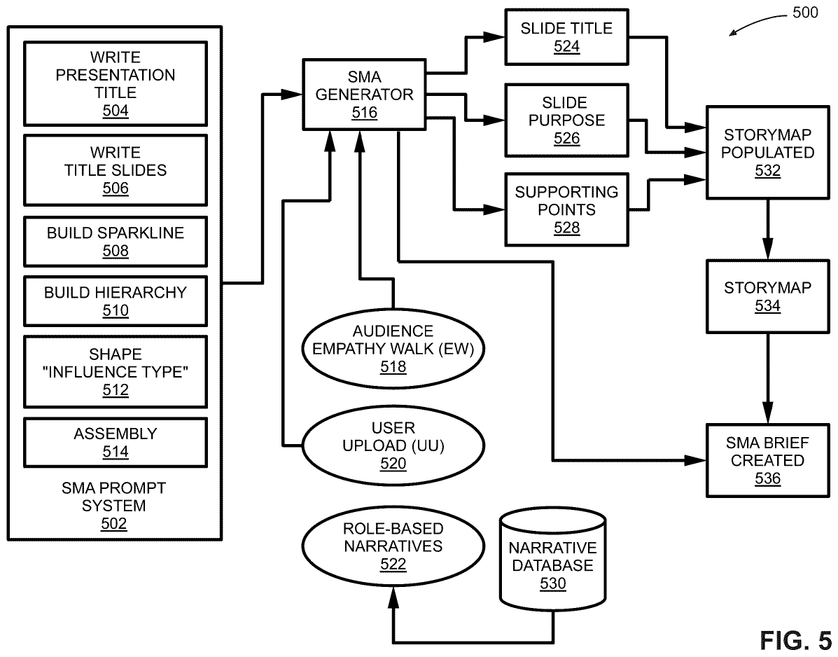

FIG. 5 is a flow diagram depicting a slidemap architect (SMA) process 500. As depicted, the slidemap architect 206 includes a slidemap architect generator 516, that integrates data from various sources. This data includes data from the SMA prompt system 502, the audience empathy walk 518, the user upload 520, and one or more role-based narratives 522 generated from narrative database 530.

In an aspect, the SMA prompt system also includes the following data structures/components:
Write presentation title 504: Enables the slidemap architect 206 to generate a presentation title.
Write title slides 506: Enables the slidemap architect 206 to generate a title for each slide.
Build sparkline 508: Enables the slidemap architect 206 to build a sparkline for the audience.
Build hierarchy 510: Enables the slidemap architect 206 to build a hierarchical structure for the presentation.
Shape “influence type” 512: Enables the slidemap architect 206 to craft the presentation using one or more elements to influence the audience.
Assembly 514: Enables the slidemap architect 206 to build and assemble the presentation.

In an aspect, SMA generator 516 processes all the input data to generate a slide title 524, a slide purpose 526, and one or more supporting points 528. The slide title 524, slide purpose 526, and supporting points 528 are used by process 500 to create a populated story map 532, which is then used to create a storymap 534. In an aspect, storymap 524 is combined with outputs from SMA generator 516 to generate an SMA brief 536.

The process 500 may include the following aspects:
SMA generator 516 amalgamates information.
   Input Sources Integration
   SMA prompt system 502
   Audience Empathy Walk (e.g., 420)
   User Upload JSON (e.g., 414)
SMA 516 has access to Narrative Database 530 to inform content decisions and to generate role-based narratives 522.
An SMA brief 536 is created and passed to the Slide Writer 210.
Slidemap is populated in the UI.
User edits or regenerates the StoryMap structure, titles, purpose or supporting points of each slide
User may upload more documents as context for the StoryMap.
Routing outputs

The Slidemap Architect phase (e.g., process 500) orchestrates the foundational steps for generating a presentation that is both logically and narratively structured and tailored to the audience's needs. The process integrates multiple inputs, executes defined prompt systems, and outputs editable structures for user interaction. Below are the steps involved:

### Input Sources Integration

The Audience Empathy Walk (EW) 518 captures audience-specific insights, such as their roles, goals, and challenges, providing an empathy-driven foundation for crafting a presentation.

The User Upload (UU) 520 enables users to contribute their existing content or data, including slides, narratives, or documents, which serve as the raw material for the presentation.

The Narrative Database 530 acts as a repository of role-based narratives, reusable templates, and industry-specific content. This database informs the creation of coherent and impactful slide purposes, titles, and supporting details.

### SMA Prompt System 502

A specialized set of sequentially designed prompts directs the system (i.e., SMA generator 516) to perform key actions, such as:
Writing a presentation title (504).
Writing slide titles and purposes (506).
Building a narrative “sparkline” (the cathartic arc of the presentation) (508).
Crafting a hierarchy of ideas (510).
Shaping the “influence type” based on the audience and context (512).
Synthesizing all inputs into a cohesive structure (514).
SMA Generator 516:

This component amalgamates inputs from the Audience Empathy Walk 518, User Upload 520, Narrative Database 530, and the SMA Prompt System 522.

The generator creates the SMA Brief (536), which serves as a comprehensive outline of the presentation. In an aspect, SMA brief 536 includes:
Slide titles.
Each slide's purpose.
Primary and secondary points.
Audience empathy elements.
Design recommendations and dependencies.
Narrative structure and flow.
StoryMap Creation (532, 536):

The Slidemap Architect 206 generates a StoryMap 534, which serves as a visual representation of the slide sequence in the application. This includes:
Each slide's title.
Each slide's purpose.
Each slide's supporting points.

This StoryMap 534 is immediately displayed in the user interface (UI) (e.g., on user computing system 102) as a loading screen or navigational map. Users can view how the content is organized in sequence.

### User Interaction With the StoryMap

Users can interact with the StoryMap 534 in the UI to rearrange slides, edit or regenerate slide titles, purposes, and supporting points. This interactive functionality enables real-time customization.

Any edits made by the user dynamically update the SMA Brief 536, ensuring seamless integration of user modifications into the system's workflow. This closed-loop process ensures alignment between the user's intent and the output generated by the Slide Writer.

### Routing Outputs

Once finalized, the outputs from the Slidemap Architect are routed to additional modules such as:
Influence Matrix (428), which ensures persuasive strategies are embedded into the final content.
Empathy Walk routing (424), which ties audience insights into the output structure.
Brand Guidebook routing (416), which ensures consistency with organizational branding.

This end-to-end process 500, guided by the Slidemap Architect 206, creates a robust and adaptable system that supports user customization as it sets up the Slide Writer to be successful in writing what the audience needs to generate a visually and narratively cohesive presentation.

Next, when the prompt system continues processing the outline, it generates the titles and the purpose of the presentation first, and then continues working on the outline so that a single brief can be created by the Slidemap Architect.

The output of the Slidemap Architect brief 536, along with other inputs from the Empathy Walk phase, are transmitted to the Slide Writer phase.

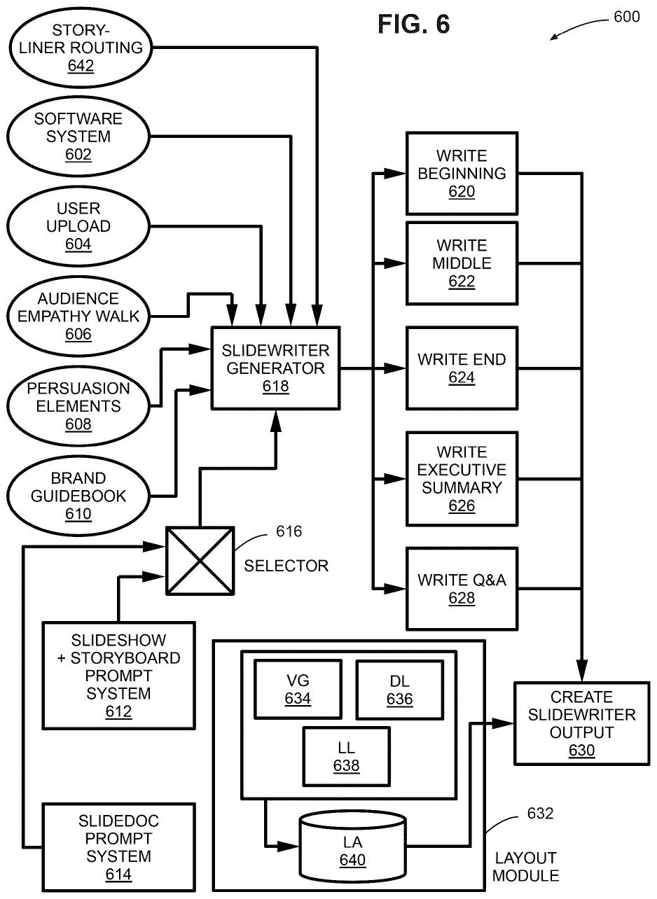

FIG. 6 is a flow diagram depicting a Slide Writer (SW) process 600. In process 600, slidewriter generator 618 (e.g., a component of slidewriter 210) receives inputs from multiple sources, and process these inputs to generate aspects of a presentation. As depicted, slidewriter generator may receive the following inputs:
Inputs 642 from storyliner routing
Inputs 602 from a software system
Inputs 604 from user upload(s) (e.g., 402)
Inputs 606 from an audience empathy walk (e.g., 420)
Inputs 608 from persuasion elements (e.g., 426/428)
Inputs 610 from a brand guidebook (e.g., 408)
Inputs from a slideshow +storyboard prompt system 612 or from a slidedoc prompt system 614 via selector 616.

Slidewriter generator 618 may then, for the presentation/narrative, write:
A beginning 620
A middle 622
An end 624
An executive summary 626
A question-and-answer (Q&A) 628

In an aspect, beginning 620, middle 622, end 624, executive summary 626, and Q&A 628 are combined with outputs from layout module 632 to generate slidewriter output 630. Slidewriter output 630 maybe output by slidewriter 210.

In an aspect, layout module 632 may be configured to generate outputs based on layout architect 640, which contains visual guide 634, diagram logic 636, and layout logic 638.

Process 600 may include the following aspects:
Slide Writer 210 amalgamates information from different data sources, such as:
   A system prompt
   SMA brief with or without user changes
   User Upload
   Audience Empathy Walk
   Persuasion Elements
   Brand Guidebook
   Slidedoc, Slideshow or Storyboard Prompt System (depending on initial user choices)
Slide Writer 210 queries the Upload Database 410 and a Visual Database.
The presentation is written (620-628).

Objects and slide images are determined.

Final plan is passed to output.

In the Slide Writer phase 600, slidewriter 210 receives the inputs from the Slidemap Architect 206, and continues the process of developing the presentation. The Slide Writer Phase 600 amalgamates information from multiple sources including:
Inputs from various components:
(Software) system prompt (602)
SMA Brief (536)
User Upload (604)
Audience Empathy Walk (420)
Persuasion Elements (426-428)
Brand Guidebook (408)
Slidedoc, Slideshow, or Storyboard Prompt System (based on user selections)

Process 600 may also include:
Querying Supporting Databases: The Slide Writer 210 queries both the Upload Database 114 and the Visual Databases (e.g., database 214) within the Layout Architect 212 to retrieve relevant content, guidance, templates, diagrams, layouts and visuals. The Visual Database includes classification systems for slide templates, diagrams, and layouts based on roles, industries, and departments.
Generating the Presentation: The Slide Writer generates the presentation by dividing the work into distinct sections (e.g., beginning, middle, end, executive summary, and Q&A) (620-628). Each section is assigned to a Slide Writer 210, which operates in parallel with other slidewriters and other components of automated presentation generator 200 to optimize efficiency. In another embodiment, a single Slide Writer may handle all sections sequentially.
Object and Slide Image Determination: Using the Layout Architect 212, the Slide Writer 210 determines the appropriate layouts, diagrams, and on-slide objects, adapting the structure and visual elements as needed. The Layout Architect 212 integrates three components:
Layout Logic: Links user inputs or system-generated decisions to specific slide layouts or filenames.
Diagram Logic: Provides diagram-based relationships, including flowcharts, networks, and other complex visualizations.
Visual Guide: Offers descriptive visuals, aiding in mapping ideas to visual elements.
Output Generation: Once all sections and slides are finalized, the system compiles the final presentation for output.

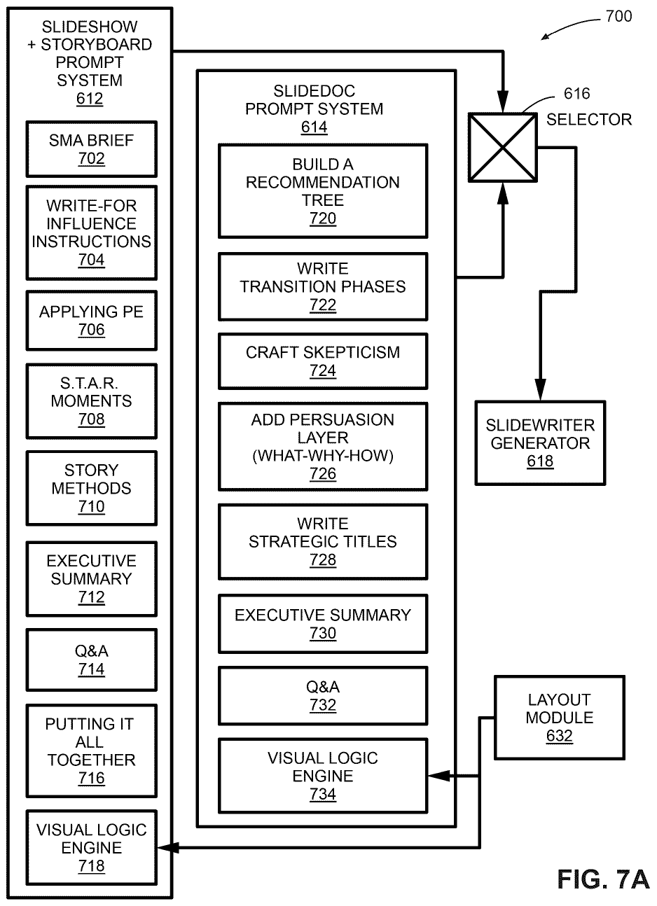

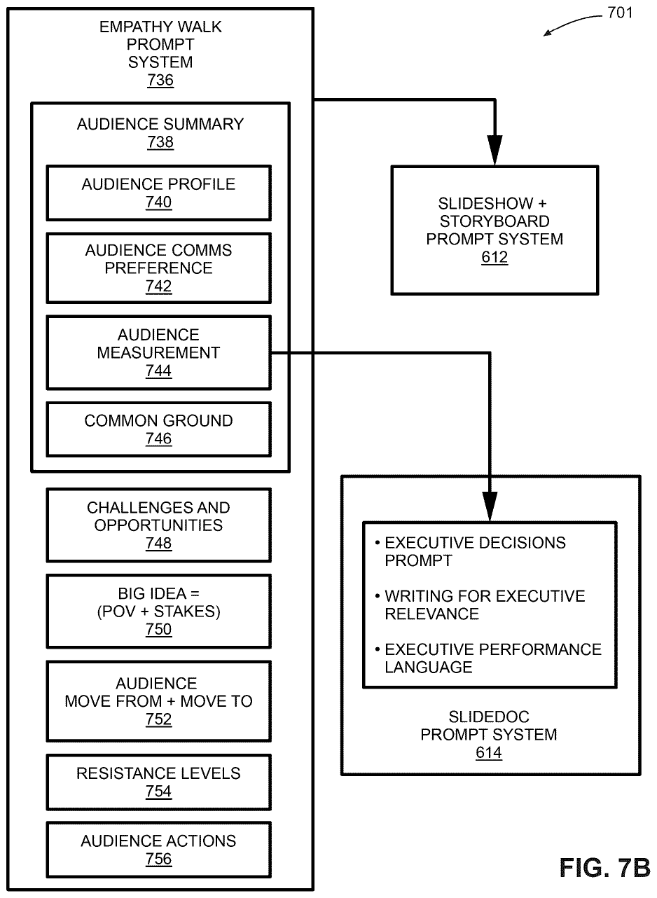

FIGS. 7A and 7B are flow diagrams depicting various interfaces between different subsystems/subcomponents of the automated presentation generator 200.

FIG. 7A depicts a process 700 that illustrates details of slideshow+storyboard prompt system 612 and slidedoc prompt system 614. As depicted, slideshow+storyboard prompt system 612 further includes:
SMA brief 702
Write-for influence instructions 704
Applying persuasive elements 706
S.T.A.R. moments 708
Story methods 710
Executive summary 712
Q&A 714
Putting it all together 716
Visual logic engine 718.

As depicted, slidedoc prompt system 614 further includes:
Build a recommendation tree 720
Write transition phases 722
Craft skepticism 724
Add persuasion layer (what-why-how) 726
Write strategic titles 728
Executive summary 730
Q&A 732
Visual logic engine 734

Outputs from either slideshow+storyboard prompt system 612 or slidedoc prompt system 614 are selected by selector 616 and output to slidewriter generator. In an aspect, both Outputs from either slideshow+storyboard prompt system 612 and slidedoc prompt system 614 receive inputs from layout module.

FIG. 7B is a flow diagram depicting interfaces 701 between empathy walk prompt system 736 and slideshow+storyboard prompt system 612, and between empathy walk prompt system 736. And slidedoc prompt system 614. As depicted, empathy walk prompt system 736 includes:
Audience summary 738
Challenges and opportunities 748
Pig idea =(POV+Stakes) 750
Audience move from+move to 752
Resistance levels 754
Audience actions 756

Audience summary further includes:
Audience profile 740
Audience communication preferences 742
Audience measurement 744
Common ground 746

In an aspect, slideshow+storyboard prompt system 612 receives data from all components of empathy walk prompt system. On the other hand, slidedoc prompt system 614 receives data from audience measurement 744. In an embodiment, slidedoc prompt system 614 may include:
An executive decisions prompt
Writing for executive relevance
Executive performance language

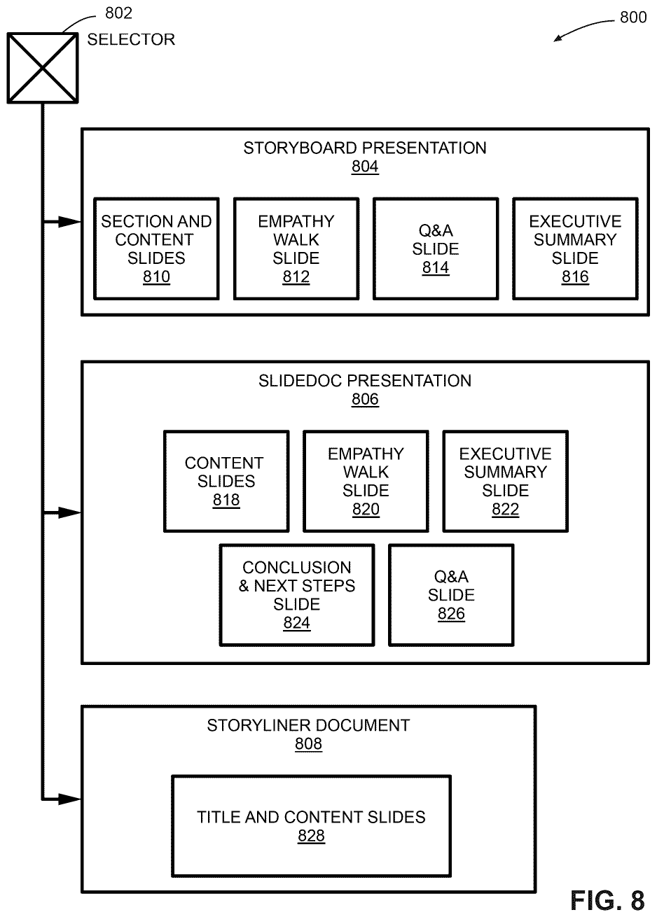

FIG. 8 is a block diagram depicting an output phase 800. In an aspect, a user can select, via selector 802, a format of the output presentation. The user may be able to select between a storyboard presentation 804, a slidedoc presentation 806, and a storyliner document 808.

In an aspect, storyboard presentation 804 includes:
One or more section and content slides 810
An empathy walk slide 812
A Q&A slide 814
An executive summary slide 816

In an aspect, slidedoc presentation 806 includes:
One or more content slides 818
An empathy walk slide 820
An executive summary slide 822
A conclusion and next steps slide 824
A Q&A slide 826

In an aspect, storyliner document 808 includes one or more title and content slides 828.

In an aspect, output phase 800 is the final phase of the automated presentation generation process, by automated presentation generator 800. The output is a Microsoft PowerPoint file (or a presentation in other file formats), that may include the following:
Empathy Walk slide: a single first slide places all the user choices from the Empathy Walk onto a skimmable formatted slide. Users reference this slide as they edit their deck after downloading to ensure empathy for the audience.
An executive summary slide which summarizes the presentation.
A slide deck that may include:
   Section heads
   Content slides
   On-slide text
   On-slide graphics
   Speaker notes
   Visual recommendations which may include:
      Thumbnail sketches of new slides
      Proposed re-use of existing slides. If it proposed reusing the user's original uploaded slide, recommendations for how to improve the slide are included.
      If slide is re-used, instructions on how to improve the slide are included.
A Q&A slide which poses questions for the presenter to consider if the audience is resistant or curious about the big idea.
An instruction slide: One slide at the end explains how to use the slideshow, storyboard or slidedoc. The instructions explain what the output is and how to use each output type.

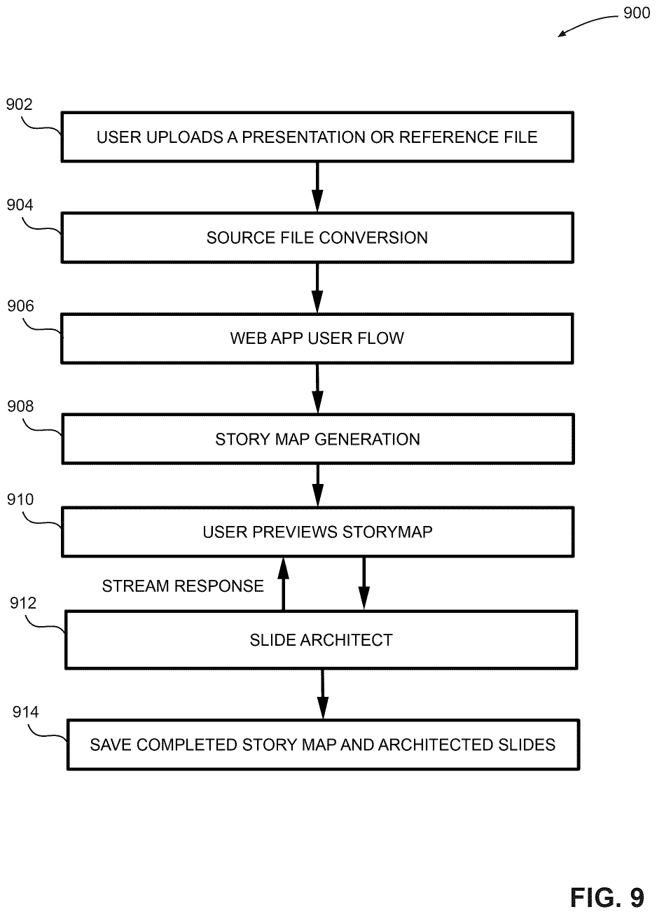

FIG. 9 is a flow diagram depicting an automated presentation generation system user workflow 900. Workflow 900 may include a user uploading a presentation or a reference file (902). In one aspect, at 902, the user initially uploads a presentation such as a . pptx presentation to the automated presentation generation system 100 (i.e., automated presentation generator 112/200). This presentation may contain basic ideas that the user wishes to present. The automated presentation generation system 100 may then guide the user through the empathy walk, to obtain additional information from the user, as described above.

Workflow 900 may include performing a source file conversion (904). In an aspect, at 904, a source file context generator accepts the presentation file, and outputs one or more images and JSON files. In an aspect, an application programming interface (API) fetches one or more prompts from a database, and:
Converts the presentation to images, and
Converts the images to JSON content using one or more large language model (LLM) calls.

Workflow 900 may include a web app user flow (906). In an aspect, the web app user flow analyzes information provided by the user, including the target audience, the big idea associated with the presentation, the intended audience journey, audience receptiveness, and call to action. The user action and other results may be stored in a database.

Workflow 900 may include story map generation (908). For example, a story map generator may use one or more APIs, to receive JSON input from the (web app) user flow, and context from the source file (e.g., the . pptx, . pdf etc.). the story map generator may process these inputs to generate a story map JSON file.

Workflow 900 may include presenting the story map to the user for preview (910). At 910, the story map JSON file generated by the story map generator may be previewed as story map slides by a user (for example, on a web app on user computing system 102). The user may provide feedback or edits to the story map slides to a slide architect (912), and the slide architect may respond back to a user (e.g., via a response stream) with the corresponding slide updates and options to upload more files. The user may then request further edits to the slides, and this iterative process continues till the user is satisfied with the slides. In one aspect, the slide architect may be implemented via an API.

Finally, at 914, the completed story map and architected slides are saved in a database for preview. The final . pptx and other format presentation (slides) can be downloaded for presentation by the user. In one aspect, AI writes output in JSON and Markdown is converted to, for example, PowerPoint (. pptx) presentation files using specifications that iterate through each slide and define elements such as text fields, charts, images and speaker notes. The JSON/Markdown specification describes both how to position the elements as well as how to reference visual style information. Previously generated PowerPoint source files can be used as templates for the content generated by AI to be applied to.

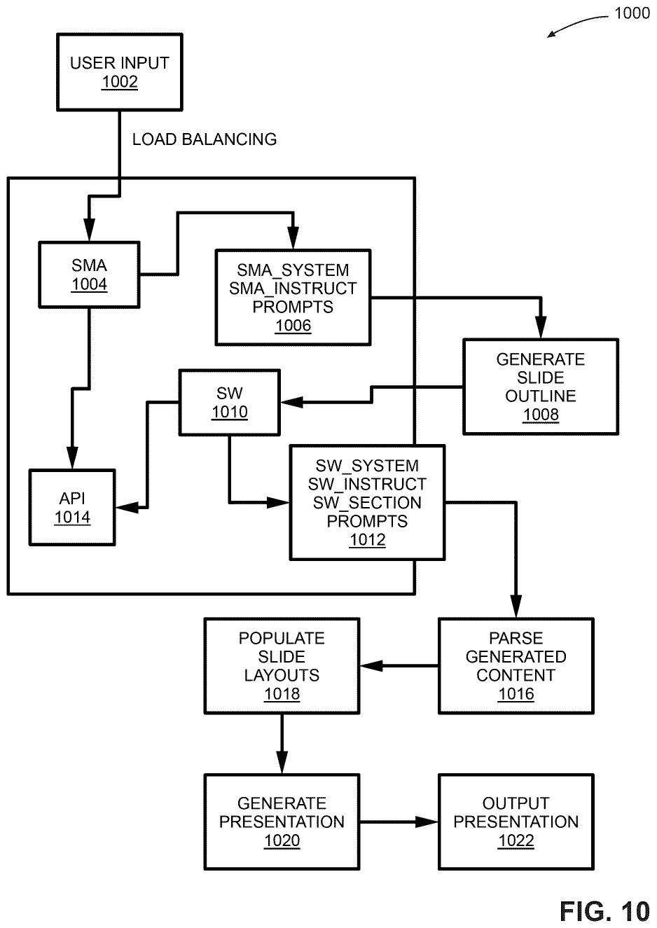

FIG. 10 is a flow diagram depicting an automated presentation generation system user workflow 1000. As depicted, in workflow 1000, the user input 1002 is load-balanced, and input to the Slidemap Architect 1004 (similar to slidemap architect 206). One or more SMA system and SMA instruct prompts 1006 may be used to generate a slide outline 1008, which is then input to the Slide Writer 1010 (similar to slide writer 210). The output of the Slide Writer 1010, along with an output of the Slidemap Architect 1004, is input to an application programming interface (API) 1014. Concurrently, the Slide Writer 1010 generates one or more prompts 1012 that enable the automated slide generator to parse generated content 1016, populate the output slide layout 1018, generate a presentation 1020 (e.g., a PowerPoint presentation), and output the PowerPoint (or other formatted) presentation files for the user (1022).

In an aspect, the user interacts with the automated presentation generation system via a graphical user interface presented to the user by the remote computing system 106, on user computing system 102.

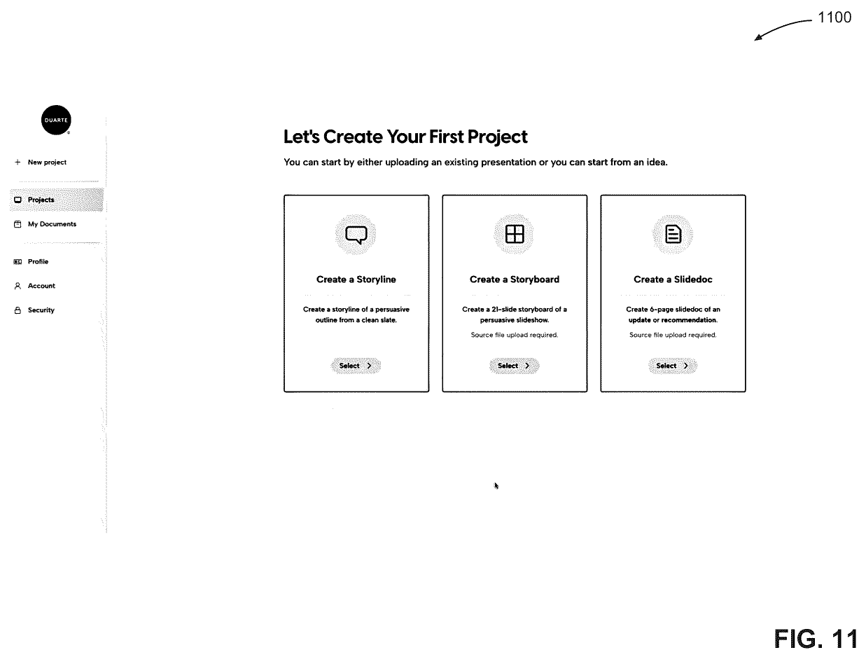

FIGS. 11 through 25 depict example screenshots presented to a user by an embodiment of the automated presentation generation system 100.

FIG. 11 is a screenshot 1100 of a graphical user interface associated with the automated presentation generation system 100. At the first stage, the user may be presented with an interface that enables the user to initialize their project. The user may be able to select between creating a storyline, a slideshow, a storyboard, or a slidedoc (e.g., a slide document). (The internal workflow associated with this selection is presented in FIG. 8.) This interface that enables the user to initialize their project is presented by screenshot 1100.

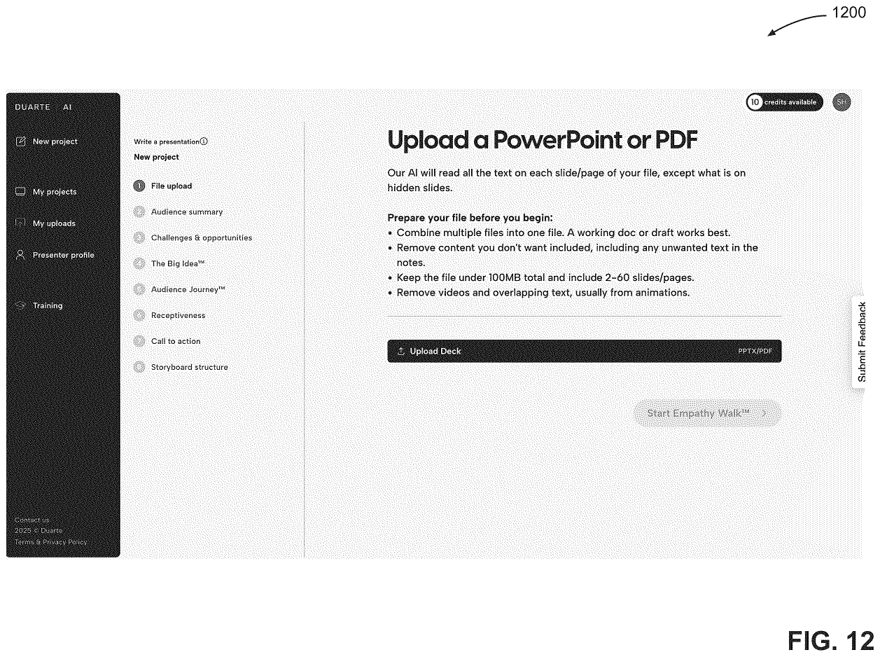

FIG. 12 is a screenshot 1200 of a graphical user interface associated with the automated presentation generation system 100. After the user makes their selection from the three choices presented in FIG. 11, the automated presentation generation system 100 prompts the user to upload their source file (e.g., the initial . pptx upload). A screenshot of this interface is presented in screenshot 1200. As seen in screenshot 1200, the automated presentation generation system is configured to process either . pptx files, . pdf files, or other file formats.

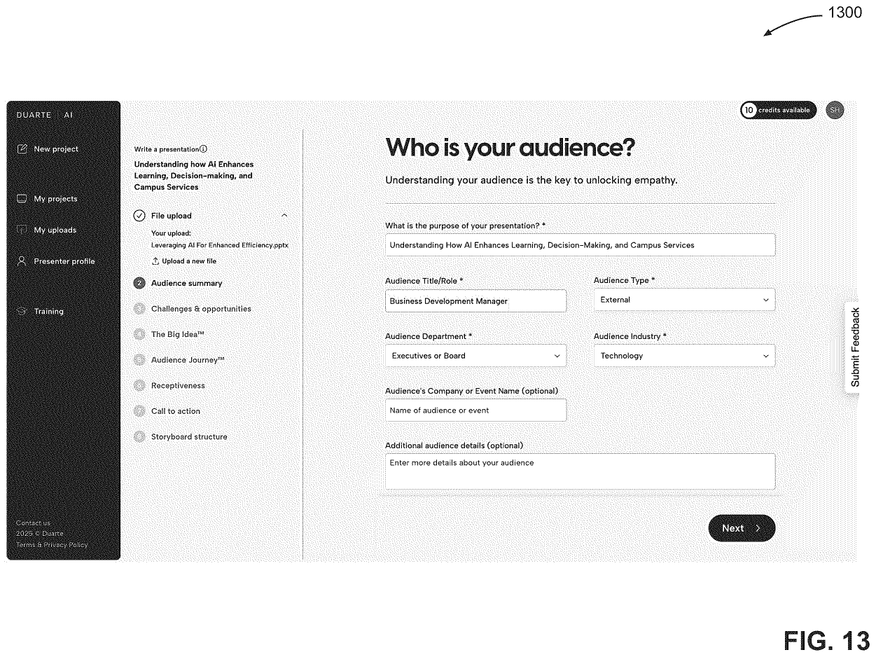

FIG. 13 is a screenshot 1300 of a graphical user interface associated with the automated presentation generation system 100. After the user upload, the automated presentation generation system 100 initiates the empathy walk for the user, where the user is presented with an interface that prompts the user to enter information about the anticipated audience. Screenshot 1300 depicts this interface.

As depicted in screenshot 1300, the user may be prompted to provide information about the intended audience (audience plan). This information may include:
Audience title/role (e.g., software engineers, business development managers, etc.)
Audience type (e.g., external to the user's organization)
Audience or event name (e.g., a seminar, a conference, etc.)
Audience department (e.g., engineering)
Audience size (e.g., small, medium, large, keynote, town hall, etc.)
Audience industry (e.g., technology)
Influence type (e.g., Educate to learn, Inspire to adopt change, Recommend for approval, Update to align.
Presentation type: Instructions to identify which narrative structure to pull from the role-based narrative taxonomy as an instruction set (e.g. A sales role need a first call deck or an entrepreneur role needs a Series A fundraise deck)
Topic of the presentation (e.g., a description of the presentation)

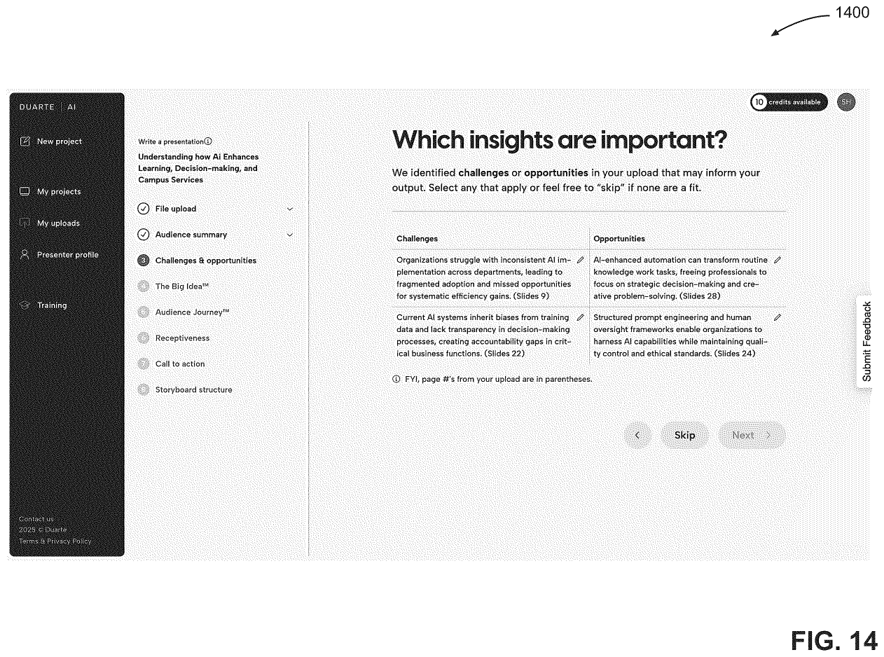

FIG. 14 is a screenshot 1400 of a graphical user interface associated with the automated presentation generation system 100. Based on the user inputs and basic presentation upload, the automated presentation generation system 100 may present to the user an insights interface that presents a list of challenges and a list of opportunities via a user interface on the user computing system 102. An example of such a user interface is presented in screenshot 1400. The user has the option of selecting one or more challenges and/or opportunities that they feel might be relevant to the current presentation, or important to them. This selection further enables the automated presentation generation system 100 to create the final presentation while accounting for the user selections associated with the challenges and opportunities.

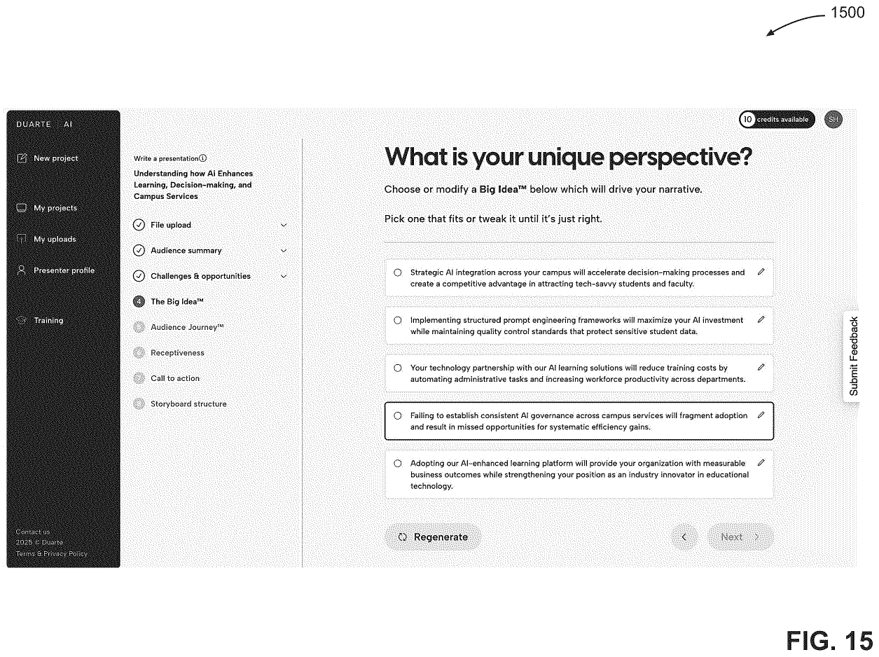

FIG. 15 is a screenshot 1500 of a graphical user interface associated with the automated presentation generation system 100. The automated presentation generation system 100 also provides the user with an interface for the user to focus on what they think is their big idea (e.g., a central theme) for the presentation. In an aspect, the automated presentation generation system 100 presents the user with a selection of big ideas for the user to review. The user can then select the big idea that they think is most relevant to their presentation. A screenshot of a user interface for selecting an appropriate big idea is shown in screenshot 1500.

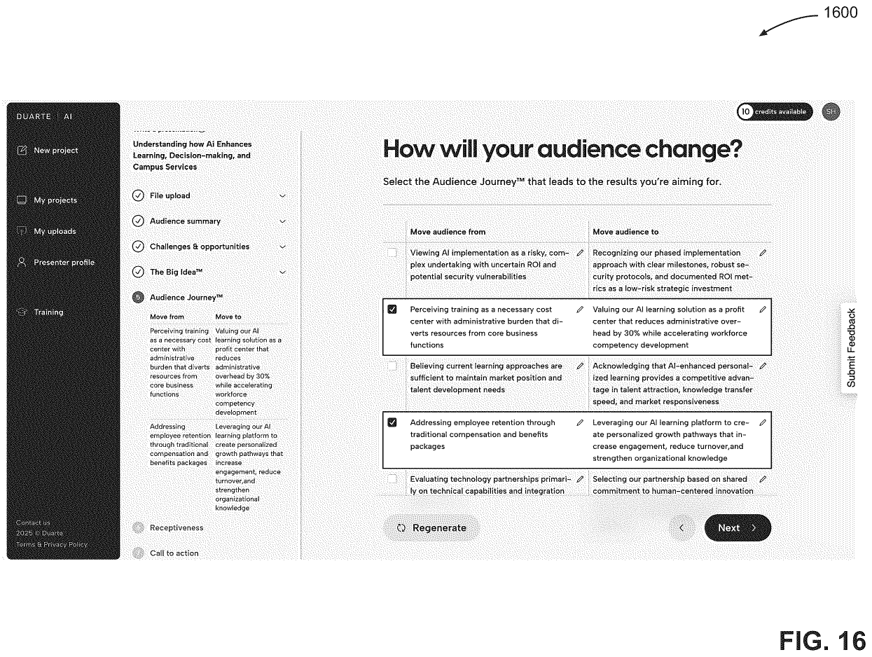

FIG. 16 is a screenshot 1600 of a graphical user interface associated with the automated presentation generation system 100. The automated presentation generation system 100 may also request additional information from the user regarding how they think that they might want to persuade the audience. To accomplish this, the automated presentation generation system presents an Audience Journey user interface to the user, presented in screenshot 1600. As shown, the user interface shown in screenshot 1600 presents one or more options to the user for generating the presentation to move the audience from one point-of-view (possibly a negative point-of-view) to another point of view (e.g., a more positive point-of-view). The user can select none of the options, or one or more of the options if they wish.

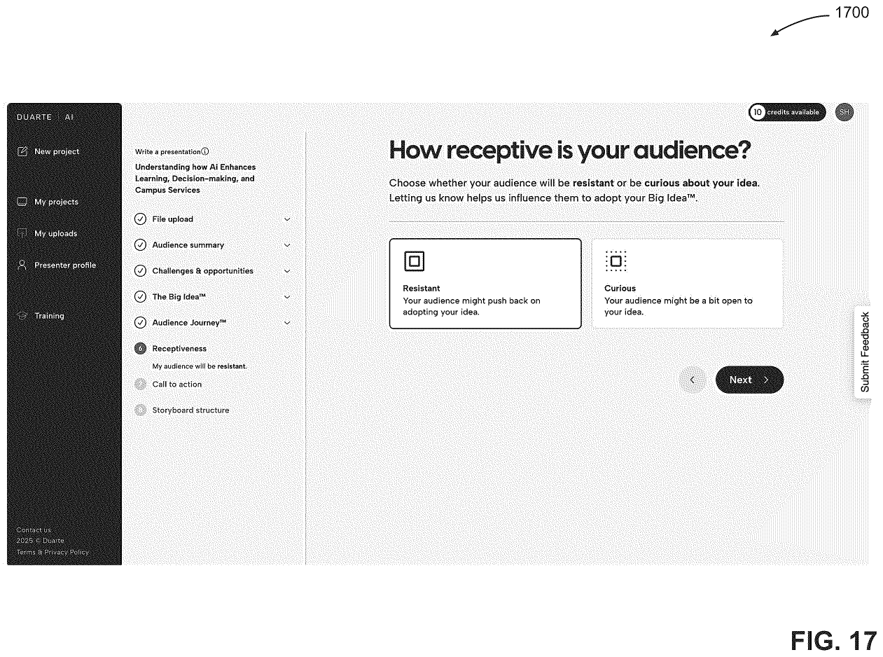

FIG. 17 is a screenshot 1700 of a graphical user interface associated with the automated presentation generation system 100. The automated presentation generation system 100 may also prompt the user to provide a user impression regarding the receptiveness of the audience. For example, as depicted in screenshot 1700, the user interface generated by the automated presentation system 100 asks the user to select whether the user thinks that the audience is resistant to the idea being presented, or curious (e.g., more receptive to the idea). The automated presentation generation system 100 accounts for this user selection when generating the final presentation.

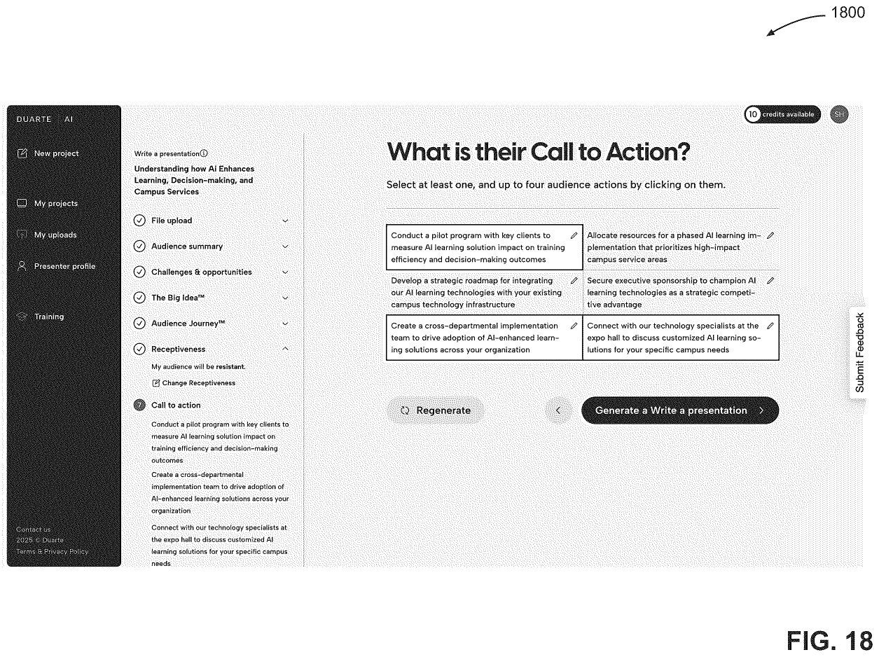

FIG. 18 is a screenshot 1800 of a graphical user interface associated with the automated presentation generation system 100. User inspiration/motivation is incorporated into the final presentation by the automated presentation generation system 100 via a user interface that offers the user one or more options to select calls to action for the audience. An example screenshot of such an interface is depicted in screenshot 100.

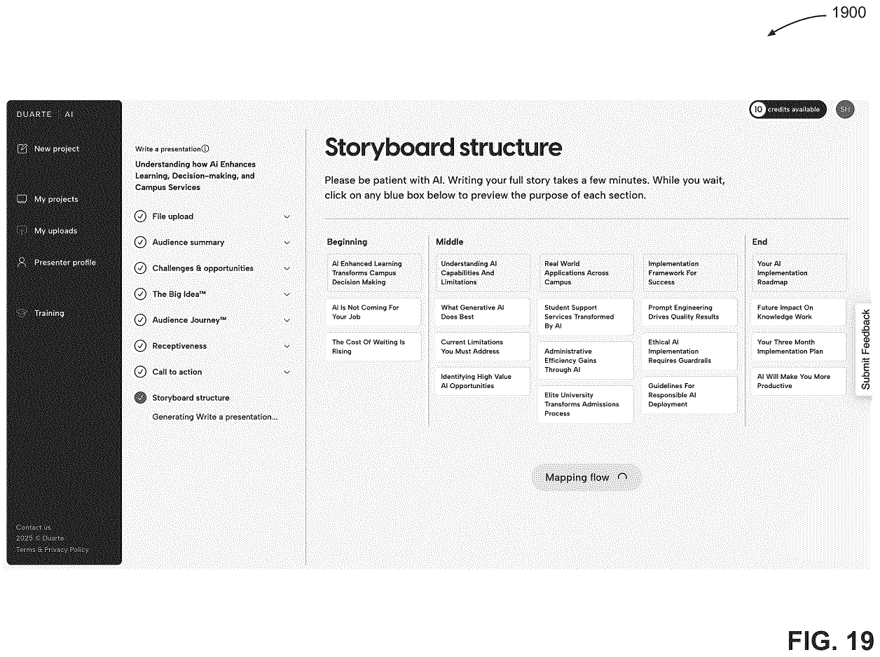

FIG. 19 is a screenshot 1900 of a graphical user interface associated with the automated presentation generation system 100. Finally, the automated presentation generation system 100 processes all inputs from the user and presents a standby screen that loads while the presentation is being prepared by the automated presentation generation system. Screenshot 1900 presents an example of the StoryMap standby screen. As shown in screenshot 1900, the user is presented with an overview of the final presentation content for review (storyboard structure). The presentation content is divided into a beginning, a middle and an end section. Each section may include one or more subsections.

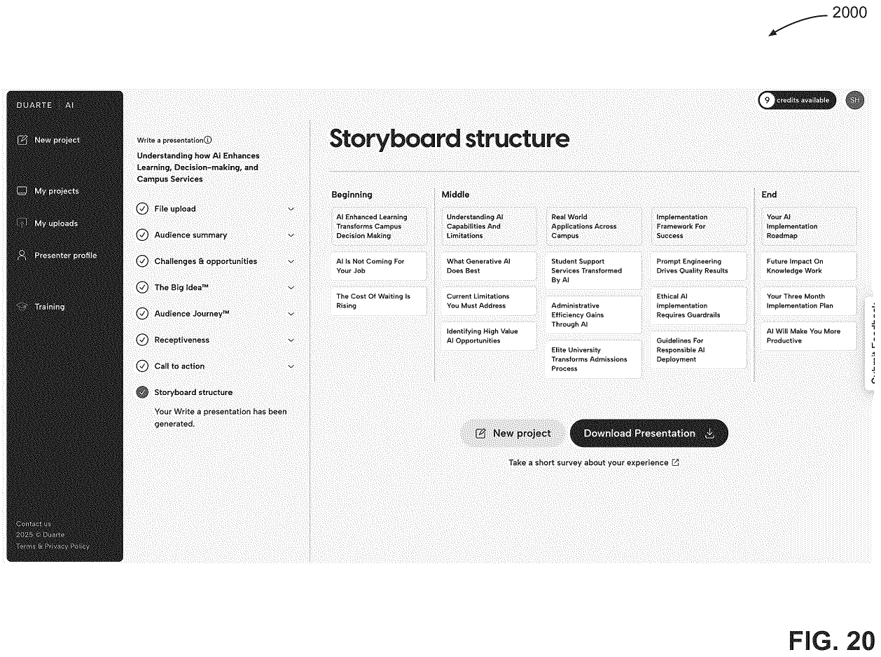

FIG. 20 is a screenshot 2000 of a graphical user interface associated with the automated presentation generation system 100. The StoryMap interface, as depicted in screenshot 2000, provides a structured and interactive environment for users to view, organize, and modify the composition of a presentation. The interface is segmented into distinct categories labeled “Beginning,” “Middle,” and “End,” with each segment containing individual slide representations in the form of discrete cards. Each card displays the slide title and, optionally, associated content such as bullet points or key supporting details. The user can download the final presentation via graphical user interface 2000.

The StoryMap interface incorporates several features to facilitate user-driven customization, including:
Drag-and-Drop Functionality: Each slide card is movable within or across sections via drag-and-drop operations. This functionality enables users to adjust the order and sequence of slides, thereby optimizing the logical flow and narrative structure of the presentation.
Inline Content Modification: Users may directly edit the content of individual slide cards by selecting a card and modifying its title or associated bullet points. These edits are performed in real-time within the interface and automatically update the underlying data model maintained by the system.
Section-Based Organization: The categorical organization of slides into Beginning, Middle, and End sections provides an intuitive structure, enhancing the user's ability to manage and refine the narrative framework of the presentation while ensuring logical continuity.
Synchronized Feedback Mechanism: Modifications executed within the StoryMap interface are automatically propagated to the corresponding Slidemap Architect (SMA) brief. This integration ensures that the user's modifications are reflected downstream in the automated processes executed by the Slide Writer phase, preserving consistency and alignment across the system.

The StoryMap interface is designed to provide users with a clear and efficient mechanism for real-time interaction with presentation content. By enabling direct modifications to the presentation structure and content, this interface enhances user control while maintaining integration with the system's automated generation processes. This design represents a critical component of the broader system, bridging user interaction with machine-driven output to deliver a seamless and customizable presentation development experience.

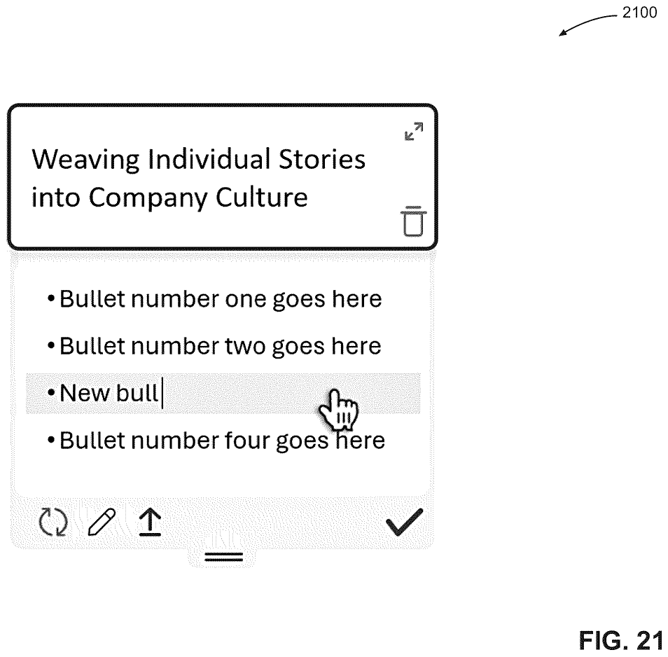

FIG. 21 is a screenshot 2100 of a graphical user interface associated with the automated presentation generation system 100. Screenshot 2100 depicts a detail of a user interface for editing in the SlideMap view.

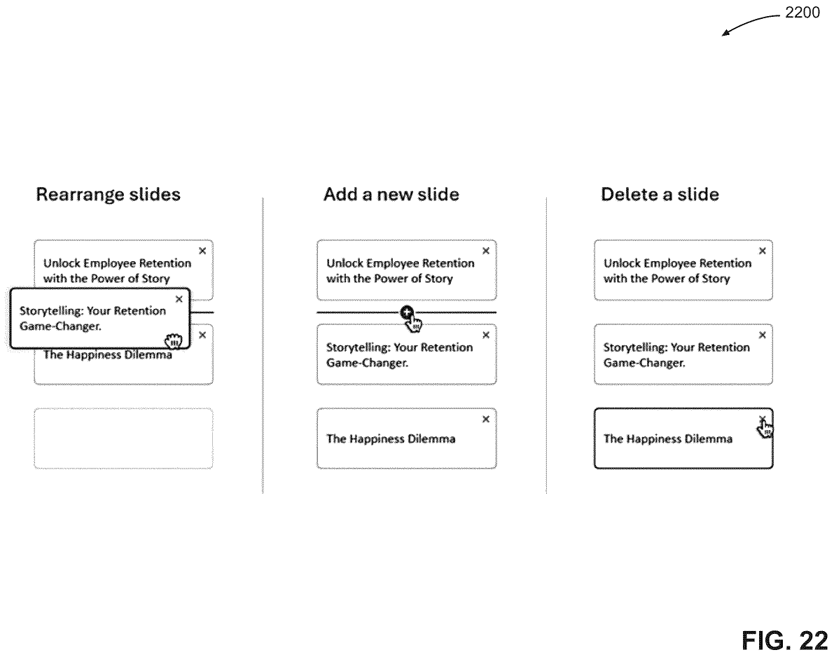

FIG. 22 is a screenshot 2200 of a graphical user interface associated with the automated presentation generation system 100. Screenshot 220 depicts a SlideMap user interface functionality.

The functionalities depicted in screenshots 2100 and 2200 showcase the user interface's interactive features for managing slides within the StoryMap interface. These functionalities enhance the user's ability to create, organize, and refine the structure and content of the presentation seamlessly. The following key features are demonstrated:
Rearrange Slides: Users can reorder slides within their designated sections by selecting a slide and dragging it to a new position. A visual indicator dynamically updates during the drag-and-drop operation, providing feedback on the slide's intended placement. This functionality ensures an intuitive reordering process, enabling users to adjust the narrative flow efficiently.
Add a New Slide: Users can insert new slides into the StoryMap by hovering between two existing slides. When the user hovers over a valid insertion point, a “+” symbol appears, accompanied by a horizontal line to indicate the potential location of the new slide. This mechanism supports slide creation at any point within a section, ensuring flexibility in adjusting content.
Delete a Slide: Each slide card includes an “X” icon or a trash can icon in the top-right corner. When clicked, this initiates a pop-up confirmation dialogue box, prompting the user to either confirm or cancel the deletion of the selected slide. This safeguard ensures that accidental deletions can be avoided while maintaining an efficient mechanism for content removal.
Upload Supporting Content: Users can enhance individual slides by uploading supplementary content directly through an “upload” icon displayed on each slide card. Clicking the icon opens a file selector, allowing users to attach relevant files such as images, documents, or multimedia assets. Once uploaded, these files are associated with the specific slide and displayed as attachments or references in the slide's content pane. This feature ensures that users can provide additional context or resources for each slide, enhancing the depth and clarity of the presentation while maintaining a centralized, intuitive workflow.

The described functionalities work together to deliver a robust, user-centered design that facilitates dynamic presentation management with the automated presentation generation system 100. These features seamlessly integrate with the underlying system, dynamically updating the SMA brief and ensuring that user-driven modifications propagate throughout the automated processes in subsequent phases. This integration ensures both ease of use for the end user and consistency across the system's output.

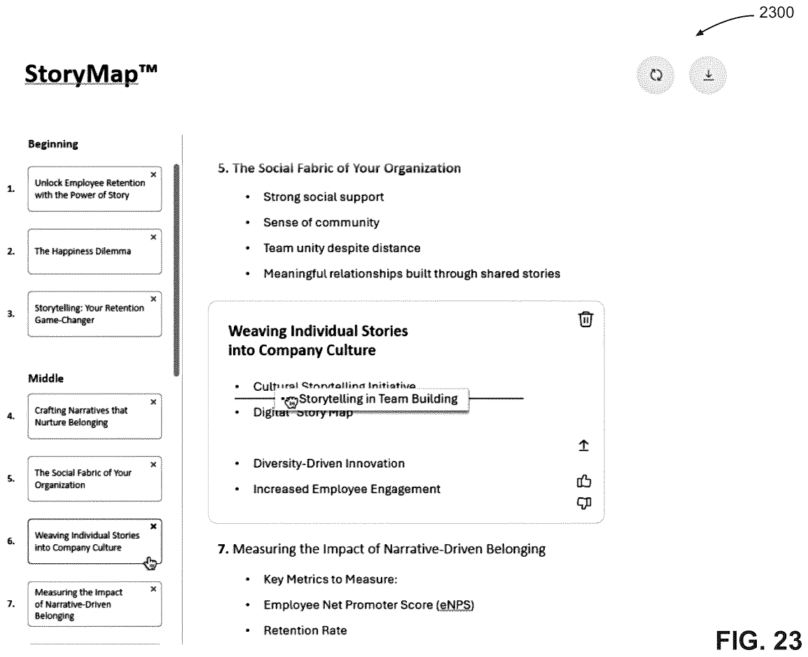

FIG. 23 is a screenshot 2300 of a graphical user interface associated with the automated presentation generation system 100. Screenshot 2300 depicts an Outline View feature within the StoryMap interface, an alternate mode that provides users with a structured and editable textual representation of their presentation content. This view focuses on enabling users to make precise adjustments to slide content, titles, and organization in a hierarchical and intuitive format.
Hierarchical Structure of Slides and Sections: The presentation is displayed as a structured hierarchy, organized into sections such as “Beginning,” “Middle,” and “End.” Each section contains a numbered list of slides with clear titles, allowing users to understand and navigate the narrative flow easily.
Editable Content Panels: Selecting a slide opens an editable content panel on the right side of the interface. This panel reveals the slide title and associated bullet points, which can be directly edited by users. For example:
   Users can click directly on bullet points to modify the text.
   A hovering cursor allows users to edit or add content dynamically, maintaining fluid interaction.
Drag-and-Drop Reordering: Users can reorder slides within a section by dragging and dropping them into a new position. The system dynamically updates the order of slides, ensuring that the narrative flow and corresponding SMA brief are synchronized.
Addition of New Content: New slides or bullet points can be inserted seamlessly. For instance, hovering between slides prompts a “+” indicator, guiding users to add new slides. Similarly, bullet points can be appended within the content panel using the “+” icon.
Deletion of Slides or Content: Slides or bullet points can be removed by selecting the “x” or “trash” icon next to the corresponding element. A confirmation dialogue ensures that accidental deletions are avoided, providing a safeguard for user edits.
Real-Time Updates to System Logic: Any edits, reordering, or additions made in the Outline View are propagated to the underlying SMA brief and associated systems. This ensures that user-driven modifications are accurately reflected in the final presentation structure and content.

The Outline View shown in screenshot 2300 enhances the user experience by providing a text-first editing interface for refining and customizing the presentation. This functionality complements the visual editing mode of the StoryMap interface, offering a dual-modality approach that accommodates varied user preferences for content manipulation and structural editing. This mode integrates seamlessly with the overall system, ensuring coherence and consistency across all stages of automated presentation generation.

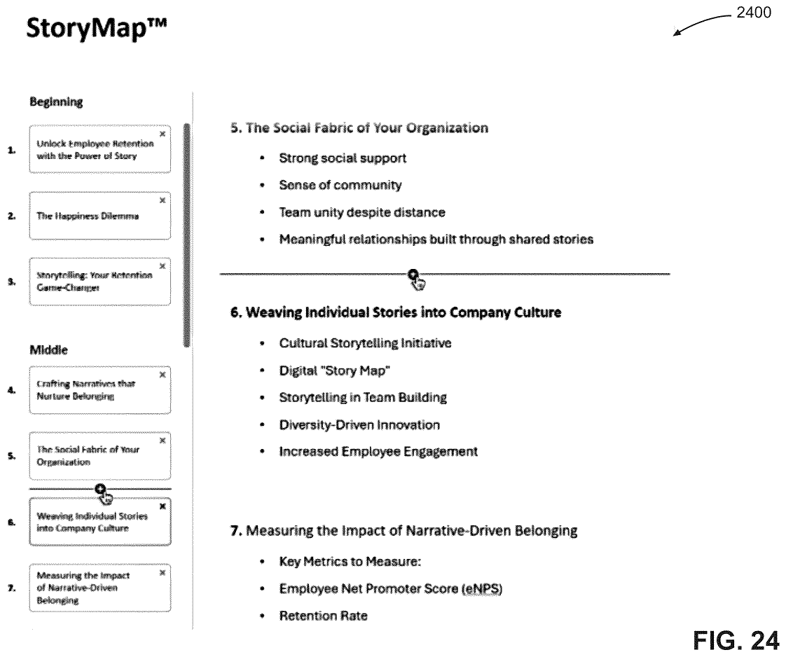

FIG. 24 is a screenshot 2400 of a graphical user interface associated with the automated presentation generation system 100. Screenshot 2400 illustrates an Add Slide Functionality within the Outline View of the StoryMap interface. This view is specifically designed to facilitate the creation and seamless integration of new slides into an existing presentation structure.
Section-Based Organization: The interface presents the slide hierarchy in sectioned groupings, such as “Beginning,” “Middle,” and “End,” with numbered slides listed under each section. This organization ensures that new slides can be contextually placed within the appropriate section of the narrative.
Interactive Slide Insertion: A “+” symbol is dynamically displayed when a user hovers between two existing slides. This indicator guides the user to add a new slide precisely where it is needed. The user clicks the “+” icon to generate a blank slide placeholder, which is automatically inserted into the sequence.
Dynamic Numbering and Reordering: When a new slide is added, the numbering of all subsequent slides in the section is updated in real time to maintain the integrity of the hierarchical order. This ensures the narrative flow remains coherent and logically structured.
Editable Slide Content: Once the new slide is inserted, the user is presented with an editable content pane where they can input the title, bullet points, and additional content directly. This ensures that the newly added slide integrates smoothly with the existing presentation framework.
Real-Time Updates to Associated Systems: The addition of a new slide triggers updates to the underlying SMA brief, ensuring that the modified structure is synchronized with subsequent systems, including the Slide Writer and Visual Logic Engine. This integration maintains alignment between the user's changes and the generated presentation content.
Cross-Section Functionality: The “+” icon and insertion functionality are consistent across all sections, allowing users to add slides to any part of the presentation with equal ease. This uniform design reduces user friction and ensures a seamless experience.

This functionality provides users with precise control over the insertion of new content in Outline View, reinforcing the adaptability and user-centric design of the StoryMap system. The integration of real-time updates and hierarchical alignment ensures that user modifications are accurately reflected across all downstream processes in the automated presentation generation system 100.

Once the automated presentation system 100 has completed generating the presentation, the finalized presentation is made available by remote computing system 106 for download on user computing system 102 via network 104.

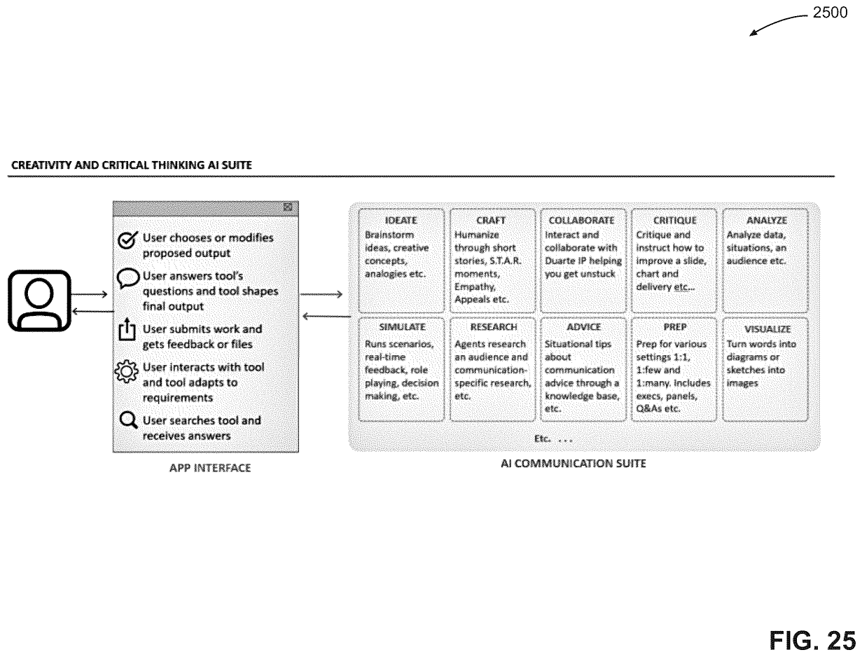

FIG. 25 is a screenshot 2500 of a graphical user interface associated with the automated presentation generation system 100. In addition to automated presentation generator 112, remote computing system 106 may also host one or more tools for enhancing interactive creativity and critical thinking. The tools may be implemented on remote computing system 106 as an AI communication suite.

The AI Communication Suite automates how users approach communication tasks by providing modular, task-specific tools embedded into a unified app interface for creativity and critical thinking in the flow of work. Unlike traditional AI-powered solutions, this suite offers tailored communication challenges, enabling users to ideate, craft, critique, and refine presentations and other communication tasks in an automated or interactive way. In one aspect, the AI communication suite ensures users achieve higher efficiency, clarity, and empower them in the flow of their work.

### AI Communication Suite Architecture

In one aspect, the AI communication suite is architected as a modular platform, where each tool operates as a stand-alone solution that integrates seamlessly into the app interface via APIs and iFrames. While each tool functions independently, the app layer facilitates user interaction and manages workflows. Other embodiments include the tools working collaboratively to offer solutions for more complex communication processes. The architecture supports scalability of additional tools as user needs evolve.

### Workflow Integration

The user workflow begins by a user selecting or modifying proposed outputs and proceeding through guided steps, including answering the tool's questions, submitting work for feedback, and receiving actionable insights (as depicted in screenshot 2500). The system adapts dynamically to user input, leveraging logic trees, taxonomies, reasonings and databases with proprietary instruction sets to guide users through tasks like brainstorming ideas, analyzing audience needs, or critiquing visual presentations.

### Technical Implementation

Each tool in the AI communication suite is powered by a deep knowledge base that includes taxonomies, systems, and training sets derived based on data collected from areas such as business storytelling, presentation development, and communication. The tools utilize foundational large language models (LLMs) as a base, and may be further trained with proprietary datasets and methodologies. This includes narrative structures, problem identification, pattern recognition, synthesis, data sets and execution techniques. Other embodiments include custom-tuned LLMs for even deeper alignment with proprietary frameworks.

### Creativity and Critical Thinking Tools

The AI communication suite fosters creativity by challenging users to explore unconventional solutions, rethink assumptions, and simulate real-world scenarios. Critical thinking tools enable users to identify biases, uncover patterns, see flaws in their execution and refine their problem-solving approaches through feedback mechanisms powered by advanced data sets and logic. The tools are integrated into users'workflows, ensuring accessibility and usability during active work processes. User feedback is delivered through structured and coded outputs that deliver actionable steps for improvement in how users communicate. These tools would be used in the flow of work to help users get unstuck while crafting empathetic communications.

### User Interaction

The app interface supports diverse interaction modes, from conversational prompts to detailed instructional guides. Depending on the tool, users may receive tailored responses or comprehensive reports. For example, users uploading a chart may receive a detailed analysis with suggestions for improvement and bias removal. In one aspect, the tools do not yet adapt autonomously over time, human oversight ensures continuous updates based on user feedback to enhance effectiveness. Another aspect may include the tools automatically adapting automatically.

### Use Cases

The AI Communication Suite supports a wide array of professional tasks, as illustrated in the AI Communication Suite screenshot 2500. Users can brainstorm creative ideas (Ideate), humanize narratives through storytelling frameworks (Craft), analyze complex data (Analyze), simulate decision-making scenarios (Simulate), and so on. Each category has several tools within it to address specific pain points, ensuring users achieve their communication objectives efficiently while working.

### Future-Proofing and Scalability

The modular architecture of the AI communication suite ensures scalability, allowing new tools to be added as user needs evolve. In one aspect, tools may be interconnected to create more comprehensive workflows that address multi-faceted communication challenges. This design ensures the suite remains relevant and adaptable to emerging trends in communication and AI technology.

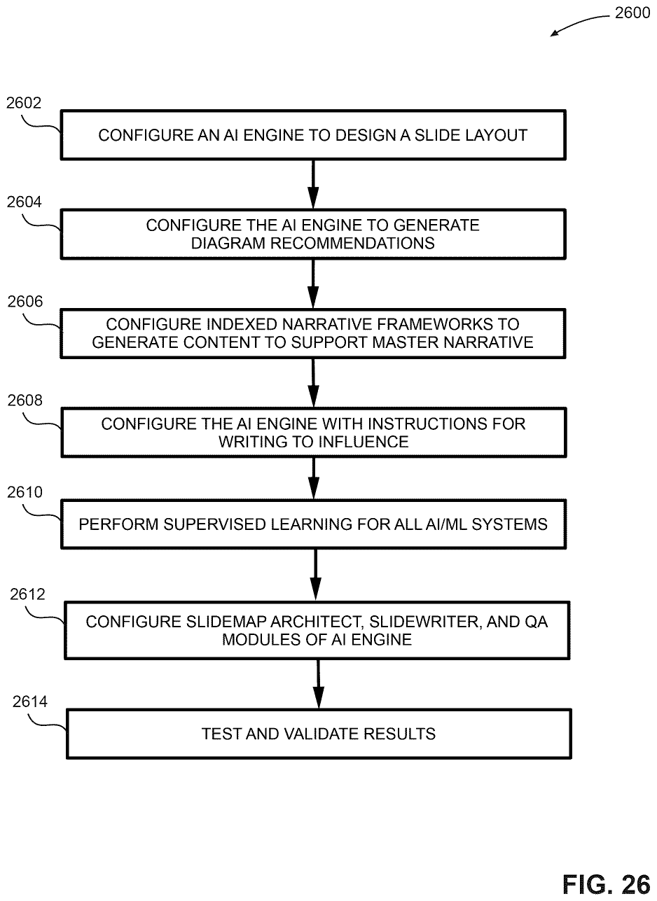

FIG. 26 is a flow diagram of a method 2600 for configuring an AI engine. Method 2600 may be used to configure AI processor 314 to perform the operations of automated presentation generator 112/200 (e.g., automatically generating a presentation based on user uploads).

Method 2600 may include configuring an AI engine to design a slide layout (2602). For example, AI processor 314 may be configured to design a slide layout.

Method 2600 may including configuring the AI engine to generate diagram recommendations (2604). For example, AI processor 314 may be configured to generate one or more diagram recommendations.

Method 2600 may include configuring indexed narrative frameworks to generate content that supports a master narrative (2606). For example, AI processor 314 may be configured to generate content that supports a master narrative for the end presentation.

Method 2600 may include configuring the AI engine with instructions for writing to influence (2608). For example, AI processor 314 may be configured to write content to influence an audience.

Method 2600 may include performing supervised learning for all AI/ML systems (2610). For example, supervised learning may be performed during a configuration process of AI processor 314. Configuring slidemap architect,

Method 2600 may include configuring slidemap architect, slidewriter and QA modules of the AI engine (2612). For example, AI processor 314 may be configured to implement functionalities of slidemap architect 206, slidewriter 210, and Q&A 714/732.

Method 2600 may include testing and validating results (2614). For example, a performance of AI processor 314 to implement the functionalities of automated presentation generator 200 may be tested and validated to ensure that automated presentation generation system 100 performs to the required standards.

The training process for the Automated Presentation Generator AI (e.g., AI processor 314) is designed to create a sophisticated and adaptive system capable of generating persuasive, audience-specific presentations by leveraging proprietary taxonomies, iterative reinforcement learning, and dynamic input-output workflows. Below is a detailed description of the training methodology (expanding on method 2600):

### 1. Data Collection and Preprocessing

### 1.1 Data Sources:

Proprietary Content: The training data includes data related to slide-writing, design, and speaker coaching derived from:
Published books.
Proprietary workshops.
Custom-built content tailored for NLP applications.
Corpora of Persuasive Text: Additional corpora are drawn from persuasive communication work examples across a wide range of industries.

### 1.2 Preprocessing Steps:

Hierarchy and Tagging: Data is structured into structural and hierarchical formats with extensive tagging slide-by-slide visual instructions and positional hierarchy.
Taxonomy Integration: Proprietary taxonomies, including Layout Logic, Diagram Logic, Narrative Taxonomy, and instructions for persuasive writing, are encoded into the training data to guide the AI in recognizing and implementing narrative and visual structures.

### 2. Embedding Proprietary Taxonomies

### 2.1 Layout Logic: A Syntax System Trains the AI to:

Recognize slide layouts.
Make layout decisions that align speaker notes with visual elements while adhering to the constraints of the presentation medium.

### 2.2 Diagram Logic: A Syntax System Trains the AI to:

Identify content suitable for diagrams.
Determine optimal diagram structures.
Generate diagram recommendations.

### 2.3 Narrative Taxonomy: Indexed Narrative Frameworks are Trained to:

Identifies role-based and industry-specific narratives.
Automate slide selection for predefined roles and presentation types (e.g., sales uses a first-call deck).
Maintain coherence with a master narrative across the deck.
Generate slide choices to support the master narrative.

### 2.4 Instructions for Writing to Influence: Training Incorporates Methodologies for Writing Content Tailored to:

Audience organizational positional hierarchies.
Industry-specific language.
Measurement criteria relevant to the audience's role.
Common ground between presenter and audience.
Structural and slide-level contrast of content (sparkline)

### 3. Training Methodologies

### 3.1 Reinforcement Learning With Human Feedback (RLHF):

### Initial Training:

The AI is initialized with pre-trained LLMs, such as Claude, ChatGPT and DALL-E and similar tools (for future visual generation).

### Iterative Refinement:

Human experts evaluate outputs from the Empathy Walk, Slidemap Architect, Slide Writer, and layout architect at each stage of the workflow.

Weekly evaluations by subject matter experts identify areas for improvement.

RLHF fine-tunes prompts, taxonomies, and constraints to align output with proprietary quality rubrics.

### 3.2 Prompt Testing Environment:

The system uses a segmented testing environment for:
Iterative refinement of individual prompt sections.
Validation of prompt performance against desired outputs.

Each stage of the workflow is tested independently to ensure conformity to proprietary rubrics.

### 4. Workflow Training and Automation

### 4.1 Slidemap Architect Training:

Trained to create structured briefs using Narrative Taxonomies.

Encodes slide-level intentions into JSON format for downstream processing by the Slide Writer.

Catalogues content from the original deck for reuse or replacement.

### 4.2 Slide Writer Training:

Learns to:
Generate on-slide text, speaker notes, and visual recommendations within defined constraints.
Enforce word count and hierarchy constraints using code-based guardrails.
Incorporate reusability decisions from the Slidemap Architect and propose new slides using the Layout Logic.

### 4.3 QA and Validation:

A QA agent (Rhetorician) enforces proprietary rubrics, such as:
Adherence to narrative and visual constraints.
Logical progression of persuasion elements.
Proprietary rhetorical devices
Feedback from QA is used to refine prompt structures and output logic.

### 5. Future Scalability with Retrieval-Augmented Generation (RAG)

### 5.1 Database Integration:

PostgreSQL is used to store:
Taxonomies and narrative frameworks.
Brand guidelines extracted from uploaded decks (e.g., RGB values, logos).

### 5.2 Dynamic Retrieval:

During inference, the system queries:
Role-specific narrative taxonomies to tailor outputs.
Historical slide content for reuse or adaptation.
Empathy walk mappings to guide persuasion strategies.

### 5.3 Enhancing Output Quality:

RAG enables dynamic integration of taxonomies into prompts, reducing input size and improving scalability.

### 6. Visual Generation with DALL-E

### 6.1 LoRA Adaptation:

Lightweight LoRA (Low-Rank Adaptation) fine-tuning trains DALL-E to:
Generate B2B-appropriate imagery.
Align with brand guidelines extracted during parsing.

### 6.2 Visual Prompting:

Prompts dynamically adjust based on:
Presentation type (e.g., slidedoc vs. slideshow).
Branding elements such as RGB values, logos, and diagram styles.

This multi-layered training process ensures that the Automated Presentation Generator AI produces audience-specific, high-quality presentations with adaptable narratives, effective persuasion, and visually aligned outputs. The combination of proprietary taxonomies, RLHF, and RAG-driven workflows establishes a defensible and innovative system for automated presentation creation.

Another aspect includes multi-agent conversational collaboration that enables users to interact with multiple domain-specific artificial intelligence expert agents in a shared virtual meeting environment. Each expert agent may also incorporate a background researcher agent that autonomously retrieves relevant information from external sources, internal knowledge bases, or language-model reasoning to support real-time expert recommendations. Users may provide text, slides, documents, audio, or video transcripts as inputs, which the system analyzes to generate structured representations of narrative, visual, or delivery-related content. A primary orchestrator agent initiates sessions, conducts intake, manages transitions among experts, and integrates user-uploaded content into the collaborative workflow. Agent dialogue, user inputs, and researcher findings dynamically update a persistent structured project representation. Users receive proposed decisions or critiques which may be refined iteratively before finalization. The system supports multi-modal interaction, multi-user participation, multilingual operation, asynchronous continuation, and export of deliverables including slide decks, reports, or coaching summaries. Some aspects of this system include:

### Background Researcher Agents

Each primary expert agent may be paired with one or more background researcher agents configured to autonomously retrieve, compile, or generate reference information relevant to the expert's domain.

Background researcher agents may monitor live conversation, extract query intent, and surface supporting data (such as industry examples, definitions, competitive insights, rhetorical patterns, or diagram types) without user intervention.

Researcher outputs may be provided directly to an expert agent, incorporated into the structured project representation, or surfaced to the user as optional informational snippets.

Researcher agents may obtain information via external APIs, internal corpora, internet search, knowledge graphs, vector databases, or language-model inference.

Researcher activity may be silent, invisible to the user, or selectively surfaced through an expert agent's dialogue.

File, Slide, and Video Transcript Ingestion

The system may accept user-uploaded assets such as presentation files, documents, slides, PDFs, audio transcripts, video transcripts, or raw text for analysis.

A converter engine may extract semantic, narrative, structural, visual, rhetorical, and temporal features from the uploaded asset.

For video transcripts or recorded talks, the system may analyze pacing, clarity, emphasis, structure, and rhetorical devices to inform expert critiques or coaching.

Agents may reference parsed content from uploads during collaboration, identifying weaknesses in storytelling, redundancy, unclear transitions, or visual inconsistencies.

Uploaded materials may be merged into the structured project representation for ongoing refinement, critique, or rework.

### Multi-Agent Meeting Environment

A system comprising multiple artificial intelligence agents with distinct domain expertise, each configured with unique reasoning and conversational behavior.

An orchestrator agent configured to initiate sessions, greet users, determine intent, and manage transitions among participating agents.

A mechanism allowing users to override the orchestrator to summon a specific expert or request a particular domain of assistance.

Agents capable of joining, leaving, or interjecting in a conversation based on deterministic routing rules, content shifts, or detected relevance.

Support for constructive inter-agent critique expressed as refinements, alternative proposals, or collaborative disagreement.

### Conversation and User Interface Embodiments

A user interface including a participant panel with agent representations, where active speakers are visually distinguished using highlighting, animation, elevation, or color-coded indicators.

A transcript panel attributing utterances to specific agents using labels or color-coded elements.

Inline decision elements rendered as accept, revise, or compare options.

Learning insights embedded within the transcript and available for later filtering or review.

Mobile embodiments using condensed agent panels with equivalent speaker indication.

### Structured Output Integration

A structured project representation that updates continuously or periodically during collaboration.

Mechanisms for synchronizing structured fields (such as audience attributes, narrative structure, and visual directives) with agent dialogue and user-uploaded content.

Indicators that signal completion of required elements within communication frameworks.

Delayed finalization of decisions until user confirmation or export.

### Multi-Modal Interaction

Support for text-only, voice-only, hybrid text-plus-voice, and audio call-in sessions.

Automatic generation of synchronized transcripts for voice interactions.

Ability to switch modalities mid-session without loss of context.

### Multi-User and Asynchronous Use

Support for multiple human participants with a primary decision-maker designated.

Ability for additional participants to observe or contribute without disrupting agent orchestration.

Asynchronous continuation with replay of prior expert sessions and resumption of structured project work.

### Language and Domain Extension

Multilingual operation with agent dialogue, transcripts, and project outputs generated in the selected language.

Extensible agent set allowing introduction of additional expert personas using the same orchestration framework.

### Output Generation

Export of structured project data into deliverables such as slide decks, reports, visuals, coaching summaries, or Q&A scripts.

Brand-aligned styling and template selection performed through integration with external presentation-generation systems.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

What is claimed is:

1. A method comprising:
receiving data, including textual data and one or more user-provided graphical elements, to create a presentation;
receiving one or more user inputs providing information regarding a context of the visual presentation, an intended audience, and an anticipated receptivity of the intended audience;
generating persuasive text for the presentation, wherein the generating is based on the data and the user inputs;
automatically selecting one or more presentation graphical elements including zero or more of the user-provided graphical elements;
generating a plurality of design elements for the presentation, the design elements comprising a combination of textual elements and the presentation graphical elements, wherein the textual elements are generated based on the persuasive text;
determining an aspect ratio for the presentation;
calculating, based on the aspect ratio, a size and a position of each of the one or more design elements, on one or more slides associated with the presentation;
resizing the design elements based on the calculating; and
finalizing the presentation by placing each design element at a respective calculated point on an associated slide.

2. The method of claim 1, wherein the generating persuasive text and generating the plurality of design elements are performed by an artificial intelligence (AI)-based system.

3. The method of claim 2, further comprising storing the received data on a database to be used by the artificial intelligence (AI)-based system for expanding a knowledge base and improving a performance of the AI-based system associated with a subsequent presentation generation process.

4. The method of claim 1, wherein the persuasive text is generated based on any combination of a positional hierarchy of the intended audience, an industry associated with the intended audience, one or more roles associated with respective individuals in the intended audience, additional user-provided context and any common beliefs and common interests shared by the intended audience and the user.

5. The method of claim 1, wherein the presentation is any of a storyline, a storyboard, a slideshow, or a slide document.

6. The method of claim 1, further comprising automatically generating a title for the presentation based on any combination of the user inputs, the persuasive text, and the design elements.

7. The method of claim 1, further comprising automatically generating any combination of on-screen text and speaker notes based on any combination of the user inputs, the persuasive text, and the design elements.

8. The method of claim 1, further comprising:
analyzing the textual data and the persuasive text; and
selecting one or more visual design elements for the presentation based on the analysis.

9. The method of claim 1, wherein the calculating further comprises:
defining one or more font sizes for one or more corresponding fonts associated with the textual elements; and
determining a size, placement and visual hierarchy for the presentation graphical elements.

10. The method of claim 1, further comprising:
providing a draft of the presentation to the user; and
iteratively modifying the presentation based on user feedback.

11. A system comprising:
a user computing system;
a remote computing system; and
a network communicatively coupling the user computing system and the remote computing system, wherein the remote computing system:
receives data from the user computing system via the network, including textual data and one or more user-provided graphical elements, to create a presentation;
receives one or more user inputs from the user computing system via the network, the user inputs providing information regarding a context of the visual presentation, an intended audience, and an anticipated receptivity of the intended audience;
generates persuasive text for the presentation, wherein the generating is based on the data and the user inputs;
automatically selects one or more presentation graphical elements including zero or more of the user-provided graphical elements;
generates a plurality of design elements for the presentation, the design elements comprising a combination of textual elements and the presentation graphical elements, wherein the textual elements are generated based on the persuasive text;
determines an aspect ratio for the presentation;
calculates, based on the aspect ratio, a size and a position of each of the one or more design elements, on one or more slides associated with the presentation;
resizing the design elements based on the calculating;
finalizes the presentation by placing each design element at a respective calculated point on an associated slide; and
transmits the presentation to the user computing device via the network.

12. The system of claim 11, wherein the generating persuasive text and generating the plurality of design elements are performed by an artificial intelligence (AI)-based system component of the remote computing system.

13. The system of claim 12, wherein the remote computing system stores the received data on a database to be used by the artificial intelligence (AI)-based system for expanding a knowledge base and improving a performance of the AI-based system associated with a subsequent presentation generation process.

14. The system of claim 11, wherein the persuasive text is generated based on any combination of a positional hierarchy of the intended audience, an industry associated with the intended audience, one or more roles associated with respective individuals in the intended audience, additional user-provided context and any common beliefs and common interests shared by the intended audience and the user.

15. The system of claim 11, wherein the presentation is any of a storyline, a storyboard, a slideshow, or a slide document.

16. The system of claim 11, wherein the remote computing system automatically generates a title for the presentation based on any combination of the user inputs, the persuasive text, and the design elements.

17. The system of claim 11, wherein the remote computing system automatically generates any combination of on-screen text and speaker notes based on any combination of the user inputs, the persuasive text, and the design elements.

18. The system of claim 11, wherein the remote computing system:
analyzes the textual data and the persuasive text; and
selects one or more visual design elements for the presentation based on the analysis.

19. The system of claim 11, wherein the calculating further comprises the remote computing system being configured to:
define one or more font sizes for one or more corresponding fonts associated with the textual elements; and
determine a size, placement and visual hierarchy for the presentation graphical elements.

20. The system of claim 11, further comprising the remote computing system being configured to:
provide a draft of the presentation to the user; and
iteratively modify the presentation based on user feedback.
